(19) United States
(12) Patent Application Publication
(10) Pub. No.: US 2024/0389018 A1
(43) Pub. Date: Nov. 21, 2024

(54) APPARATUS AND METHOD FOR POWER SAVING IN FRONTHAUL TRANSMISSION IN WIRELESS COMMUNICATION SYSTEM

(71) Applicant: SAMSUNG ELECTRONICS CO., LTD., Suwon-si (KR)

(72) Inventors: Seungmin SUNG, Suwon-si (KR); Moonheok JANG, Suwon-si (KR); Jaekyu NO, Suwon-si (KR); Byeonghee KIM, Suwon-si (KR); Hyunjoo CHOI, Suwon-si (KR)

(73) Assignee: SAMSUNG ELECTRONICS CO., LTD., Suwon-si (KR)

(21) Appl. No.: 18/666,513

(22) Filed: May 16, 2024

Related U.S. Application Data
(63) Continuation of application No. PCT/KR2022/018110, filed on Nov. 16, 2022.

(30) Foreign Application Priority Data
Nov. 16, 2021 (KR) 10-2021-0158088
Dec. 31, 2021 (KR) 10-2021-0194452

(51) Int. Cl. H04W 52/02; H04W 88/08

(52) U.S. Cl. CPC H04W 52/0206; H04W 88/085

(57) ABSTRACT

A method performed by a Distributed Unit (DU) in a wireless communication system, includes: identifying whether there are no downlink scheduling information and uplink scheduling information for a slot; when there are no downlink scheduling information and uplink scheduling information for the slot, identifying an interval without a downlink Control plane (C-plane) message, an uplink C-plane message, and a downlink User plane (U-plane) message; and generating a control signal for powering off a transmitter of the DU within the identified interval.

### CROSS-REFERENCE TO RELATED APPLICATIONS

This application is a by-pass continuation application of International Application No. PCI/KR2022/018110, filed on Nov. 16, 2022, which is based on and claims priority to Korean Patent Application Nos. 10-2021-0158088, filed on Nov. 16, 2021, and 10-2021-0194452, filed on Dec. 31, 2021, in the Korean Intellectual Property Office, the disclosures of which are incorporated by reference herein their entireties.

### BACKGROUND

### 1. Field

The disclosure relates to a wireless communication system, and more particularly, to an apparatus and method for power saving in fronthaul transmissions in a wireless communication system.

### 2. Description of Related Art

To meet a demand on wireless data traffic which has been in an increasing trend after a 4^{th} Generation (4G) communication system was commercialized, there is an ongoing effort to develop an improved 5^{th} Generation (5G) communication system or a pre-5G communication system. For this reason, the 5G communication system or the pre-5G communication system is called a beyond 4G network communication system or a post-‘Long Term Evolution’ (LTE) system.

To achieve a high data transfer rate, the 5G communication system is considered to be implemented in a super high frequency band. To reduce a propagation path loss at the super high frequency band and to increase a propagation delivery distance, beamforming, massive multiple input multiple output (MIMO), full dimensional MIMO (FD-MIMO), array antenna, analog beam-forming, and large scale antenna techniques are under discussion in the 5G communication system.

In addition, to improve a network of a system, techniques such as an evolved small cell, an advanced small cell, a cloud radio access network (RAN), an ultra-dense network, Device-To-Device (D2D) communication, a wireless backhaul, a moving network, cooperative communication, Coordinated Multi-Points (CoMP), and reception interference cancellation, or the like are being developed in the 5G communication system.

In addition thereto, Hybrid Frequency shift keying and Quadrature Amplitude Modulation (FQAM) and Sliding Window Superposition Coding (SWSC) as an Advanced Coding Modulation (ACM) technique and Filter Bank Multi Carrier (FBMC), Non Orthogonal Multiple Access (NOMA), and Sparse Code Multiple Access (SCMA), or the like as an advanced access technology are being developed in the 5G system.

With the increase in the transmission capacity in the wireless communication system, a function split which functionally splits a base station is applied. According to the function split, the base station may be split into a Digital Unit (DU) and a Radio Unit (RU). A fronthaul for communication between the DU and the RU is defined, and transmission through the fronthaul is required. A method for reducing unnecessary power waste in fronthaul transmission between the DU and the RU is required.

### SUMMARY

Provided are an apparatus and a method for power saving in an Open (O)-Radio Access Network (RAN)-based fronthaul interface in a wireless communication system.

Further, provided are an apparatus and a method for powering on and off, based on scheduling information of a Distributed Unit (DU) in an O-RAN-based fronthaul interface in a wireless communication system.

Further, provided are an apparatus and a method for powering on and off, based on scheduling information of a Radio Unit (RU) in an O-RAN-based fronthaul interface in a wireless communication system.

### SUMMARY

According to an aspect of the disclosure, a method performed by a Distributed Unit (DU) in a wireless communication system, includes: identifying whether there are no downlink scheduling information and uplink scheduling information for a slot; when there are no downlink scheduling information and uplink scheduling information for the slot, identifying an interval without a downlink Control plane (C-plane) message, an uplink C-plane message, and a downlink User plane (U-plane) message; and generating a control signal for powering off a transmitter of the DU within the identified interval.

A start timing of the interval may correspond to a first start timing of a first interval without the downlink C-plane message, a second start timing of a second interval without the uplink C-plane message, and a third start timing of a third interval without the downlink U-plane message.

An end timing of the interval may be determined based on an earliest timing among a first end timing of a first interval without the downlink C-plane message, a second end timing of a second interval without the uplink C-plane message, and a third end timing of the a interval without the downlink U-plane message.

The end timing of the interval may be determined based on a time until the transmitter of the DU is stabilized to transmit a message after the transmitter of the DU is powered on.

The method may further include: obtaining information on whether a fronthaul between the DU and a Radio Unit (RU) is used in a transmission of a synchronization plane message and whether the fronthaul is used in a transmission of a management plane message; and when the fronthaul is not used in the transmission of the synchronization plane message and the fronthaul is not used in the transmission of the management plane message, generating the control signal for powering off the transmitter of the DU within the interval.

The transmitter of the DU may further include a Physical (PHY) transmitter and an optical transmitter.

According to an aspect of the disclosure, a method performed by a Radio Unit (RU) in a wireless communication system, includes: identifying whether there is no uplink scheduling information for a slot; when there is no uplink scheduling information for the slot, identifying an interval without an uplink User plane (U-plane) message; and generating a control signal for powering off a transmitter of the RU within the interval.

A start timing of the interval may correspond to a first start timing of a first interval without the uplink U-plane message, and wherein an end timing of the interval is determined based on a first end timing of the first interval without the uplink U-plane message.

The method may further include: obtaining information on whether a fronthaul between a Distributed Unit (DU) and the RU is used in a transmission of a synchronization plane message and whether the fronthaul is used in a transmission of a management plane message; and when the fronthaul is not used in the transmission of the synchronization plane message and the fronthaul is not used in the transmission of the management plane message, generating the control signal for powering off the transmitter of the RU within the interval.

According to an aspect of the disclosure, a Distributed Unit (DU) in a wireless communication system, includes: a transmitter; and at least one processor operatively coupled to the transmitter, wherein the at least one processor is configured to: identify whether there are no downlink scheduling information and uplink scheduling information for a slot; when there are no downlink scheduling information and uplink scheduling information for the slot, identify an interval without a downlink Control plane (C-plane) message, an uplink C-plane message, and a downlink User plane (U-plane) message; and generate a control signal for powering off the transmitter of the DU within the interval.

A start timing of the interval may correspond to a first start timing of a first interval without the downlink C-plane message, a second start timing of a second interval without the uplink C-plane message, and a third start timing of a third interval without the downlink U-plane message.

An end timing of the interval may be determined based on an earliest timing among a first end timing of a first interval without the downlink C-plane message, a second end timing of a second interval without the uplink C-plane message, and a third end timing of a third interval without the downlink U-plane message.

The end timing of the interval may be further determined based on a time until the transmitter of the DU is stabilized to transmit a message after the transmitter of the DU is powered on.

According to an aspect of the disclosure, a Radio Unit (RU) in a wireless communication system, includes: a transmitter; and at least one processor operatively coupled to the transmitter, wherein the at least one processor is configured to: identify whether there is no uplink scheduling information for a slot; when there is no uplink scheduling information for the slot, identify an interval without an uplink User plane (U-plane) message; and generate a control signal for powering off a transmitter of the RU within the interval.

An apparatus and a method according to embodiments of the disclosure enable efficient power saving by powering on and off, based on scheduling information in an Open-Radio Access Network (O-RAN)-based fronthaul interface.

An apparatus and a method according to embodiments of the disclosure enable efficient power saving by powering on and off for an interval in which both a Control plane (C-plane) message and a User plane (U-plane) message are not transmitted in a wireless communication system.

In addition, aspects of the disclosure are not limited to the aforementioned aspects, and other aspects not mentioned herein may be clearly understood by those skilled in the art to which the disclosure pertains from the following descriptions.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to one or more embodiments of the disclosure;

FIG. 2 illustrates an example of a fronthaul structure based on a functional split of a base station according to one or more embodiments of the disclosure;

FIG. 3A illustrates a structure of a Digital Unit (DU) according to one or more embodiments of the disclosure;

FIG. 3B illustrates a structure of a Radio Unit (RU) according to one or more embodiments of the disclosure;

FIG. 4 illustrates an example of a function split;

FIG. 5A illustrates a scheduling scenario in an Open-Radio Access Network (O-RAN)-based fronthaul interface according to embodiments of the disclosure;

FIG. 5B illustrates an example of a structure of a base station in an O-RAN-based fronthaul interface according to embodiments of the disclosure;

FIG. 6 illustrates examples of a protocol structure of messages in an O-RAN-based fronthaul interface according to embodiments of the disclosure;

FIG. 7 illustrates an example of an O-RAN DU (O-DU) in an O-RAN-based fronthaul interface according to an embodiment of the disclosure;

FIG. 8 illustrates an example of information input to a power saving device and a signal output thereto in an O-RAN-based fronthaul interface according to embodiments of the disclosure;

FIG. 9 illustrates an example of an interval in which a C-plane message and a U-plane message are transmitted in an O-RAN-based fronthaul interface according to embodiments of the disclosure;

FIG. 10 illustrates an example of an interval of saving power in an O-RAN-based fronthaul interface according to embodiments of the disclosure;

FIG. 11 illustrates a flowchart for saving power in a power saving device in an O-RAN-based fronthaul interface according to an embodiment of the disclosure;

FIG. 12 illustrates a flowchart for saving power in a power saving device of a DU in an O-RAN-based fronthaul interface according to an embodiment of the disclosure; and

FIG. 13 illustrates a flowchart for saving power in a power saving device in an RU in an O-RAN-based fronthaul interface according to an embodiment of the disclosure.

With regard to the description of the drawings, the same or similar reference numerals may be used to refer to the same or similar elements.

### DETAILED DESCRIPTION

Terms used in the disclosure are for the purpose of describing particular embodiments only and are not intended to limit other embodiments. A singular expression may include a plural expression unless there is a contextually distinctive difference. All terms (including technical and scientific terms) used herein have the same meaning as commonly understood by those ordinarily skilled in the art disclosed in the disclosure. It will be further understood that terms, such as those defined in commonly used dictionaries, should be interpreted as having a meaning that is consistent with their meaning in the context of the relevant art, and will not be interpreted in an idealized or overly formal sense unless expressly so defined herein. Optionally, the terms defined in the disclosure should not be interpreted to exclude the embodiments of the disclosure.

A hardware-based approach is described for example in the one or more embodiments of the disclosure described hereinafter. However, since the one or more embodiments of the disclosure include a technique in which hardware and software are both used, a software-based approach is not excluded in the embodiments of the disclosure.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

In addition, although an expression ‘greater than’ or ‘less than’ is used in the disclosure to determine whether a specific condition is satisfied (or fulfilled), this is for exemplary purposes only and does not exclude an expression of ‘greater than or equal to’ or ‘less than or equal to’. A condition described as ‘greater than or equal to’ may be replaced with ‘greater than’. A condition described as ‘less than or equal to’ may be replaced with ‘less than’. A condition described as ‘greater than or equal to and less than’ may be replaced with ‘greater than and less than or equal to’.

Terms used hereinafter to refer to a signal (e.g., a message, information, a preamble, a signal, signaling, a sequence, a stream), terms used to refer to a path (e.g., a port, a stream, a layer, a Radio Unit (RU) port, a Digital Unit (DU) port, a FrontHaul (FH) port, an input unit, an output unit, an input node, an output node, an end node), terms used to refer to a resource (e.g., a symbol, a slot, a subframe, a radio frame, a subcarrier, a Resource Element (RE), a Resource Block (RB), a Bandwidth Part (BWP), an occasion), terms used to refer to an operational state (e.g., a step, an operation, a procedure), terms used to refer to data (e.g., a packet, a user stream, information, a bit, a symbol, codeword), terms used to refer to a channel, terms used to refer to control information (e.g., Downlink Control Information (DCI), Medium Access Control (MAC) Control Element (CE), Radio Resource Control (RRC) signaling), terms used to refer to network entities, terms used to refer to a constitutional element of a device, or the like are exemplified for convenience of explanation. Therefore, the disclosure is not limited to the terms described below, and thus other terms having the same technical meaning may also be used.

In addition, although the disclosure describes one or more embodiments by using terms used in some communication standards (e.g., 3^{rd} Generation Partnership Project (3GPP), extensible Radio Access Network (xRAN), Open-Radio Access Network (O-RAN)), this is for exemplary purposes only. One or more embodiments of the disclosure may be easily modified and applied to other communication systems.

In the disclosure, a meaning of ‘slot’ may vary depending on a supported communication system. In a New Radio (NR) communication system, the ‘slot’ refers to 14 symbols (or symbol groups). Unlike the NR communication system, in the 3GPP standard of LTE, the ‘slot’ refers to 7 symbols. In Global System for Mobile communications (GSM), the ‘slot’ is a time slot, and 8 time slots correspond to one Timed Division Multiplexing Access (TDMA) frame. In other words, the meaning of slot may vary depending on the communication system. For example, in the LTE communication system, the “slot” is correlated with an LTE “Transmission Time Interval (TTI)” defined in 3GPP.

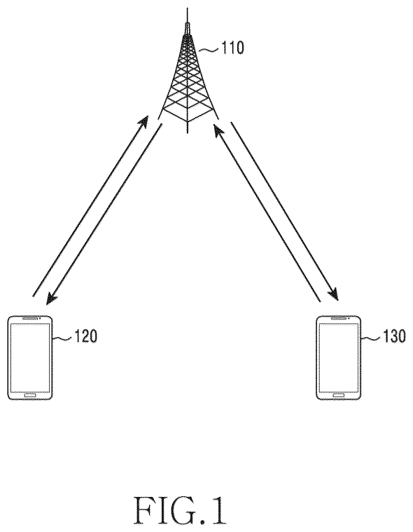

FIG. 1 illustrates a wireless communication system according to one or more embodiments of the disclosure. As part of nodes which use a radio channel, a base station 110, a terminal 120, and a terminal 130 are exemplified in the wireless communication system of FIG. 1. Although only one base station is illustrated in FIG. 1, other base stations identical or similar to the base station 110 may be further included.

The base station 110 is a network infrastructure which provides a radio access to the terminals 120 and 130. The base station 110 has a coverage defined as a specific geographic region, based on a distance capable of transmitting a signal. In addition to the term ‘base station’, the base station 110 may be referred to as an ‘Access Point (AP)’, an ‘eNodeB (eNB)’, a ‘5^{th} Generation (5G) node’, a ‘next generation NodeB (gNB)’, a ‘wireless point’, a ‘Transmission/Reception Point (TRP)’, or other terms having equivalent technical meanings.

As a device used by a user, each of the terminal 120 and the terminal 130 communicates with the base station 110 through the radio channel. A link from the base station 110 to the terminal 120 or the terminal 130 is referred to as a Downlink (DL), and a link from the terminal 120 or the terminal 130 to the base station 110 is referred to as an Uplink (UL). In addition, the terminal 120 and the terminal 130 may communicate with each other through the radio channel. In this case, a link between the terminal 120 and the terminal 130, i.e., a Device-to-Device (D2D) link, is referred to as a sidelink, and may be used interchangeably with a PC5 interface. Optionally, at least one of the terminals 120 to 130 may be operated without user involvement. That is, as a device for performing Machine Type Communication (MTC), at least one of the terminals 120 to 130 may not be carried by the user. In addition to the term ‘terminal’, each of the terminals 120 and 130 may be referred to as a ‘User Equipment (UE)’, a ‘Customer Premises Equipment (CPE)’, a ‘mobile station’, a ‘subscriber station’, a ‘remote terminal’, a ‘wireless terminal’, an ‘electronic device’, a ‘user device’, or other terms having equivalent technical meanings.

The base station 110, the terminal 120, and the terminal 130 may perform beamforming. The base station and the terminal may transmit and receive a radio signal at a relatively low frequency band (e.g., a Frequency Range 1 (FR1) of NR). In addition, the base station and the terminal may transmit and receive a radio signal at a relatively high frequency band (e.g., FR2 of NR, a millimeter Wave (mmWave) band (e.g., 28 GHz, 30 GHz, 38 GHz, and 60 GHz)). In some embodiments, the base station 110 may communicate with the terminal 120 within a frequency range corresponding to the FR1. In some embodiments, the base station may communicate with the terminal 120 within a frequency range corresponding to the FR2. In this case, to improve a channel gain, the base station 110, the terminal 120, and the terminal 130 may perform beamforming. Herein, the beamforming may include transmission beamforming and reception beamforming. That is, the base station 110, the terminal 120, and the terminal 130 may assign a directivity to a transmission signal and or a reception signal. For this, the base station 110 and the terminals 120 and 130 may select serving beams through a beam search or beam management procedure. After the serving beams are selected, subsequent communication may be performed through a resource having a Quasi Co-Located (QCL) relation with a resource used to transmit the serving beams.

If large-scale characteristics of a channel which has delivered a symbol on a first antenna port may be inferred from a channel which has delivered a symbol on a second antenna port, it may be evaluated that the first antenna port and the second antenna port have the QCL relation. For example, the large-scale characteristics may include at least one of a delay spread, a Doppler spread, a Doppler shift, an average gain, an average delay, and a spatial receiver parameter.

Although it is illustrated in FIG. 1 that both the base station and the terminal perform the beamforming, one or more embodiments of the disclosure are not necessarily limited thereto. In some embodiments, the terminal may perform, or may not perform, the beamforming. In addition, the base station may perform, or may not perform, the beamforming. That is, any one of the base station and the terminal may perform the beamforming, or both the base station and the terminal may not perform the beamforming.

Although the base station 110, the terminal 120, and the terminal 130 are exemplified in FIG. 1, embodiment of the disclosure may also apply to an Integrated Access and Backhaul (IAB) node as a newly introduced relay node. Descriptions related to the base station described in the disclosure may apply to a DU of the IAB node, and descriptions related to the terminal described in the disclosure may apply to a Mobile Terminal (MT) of the IAB node in the same or similar manner.

In the disclosure, a beam means a spatial flow of a signal in a radio channel, and is formed by one or more antennas (or antenna elements). Such a forming process may be referred to as beamforming. The beamforming may include analog beamforming and digital beamforming (e.g., precoding). Examples of a reference signal transmitted based on the beamforming may include a Demodulation-Reference Signal (DM-RS), a Channel State Information-Reference Signal (CSI-RS), a Synchronization Signal/Physical Broadcast Channel (SS/PBCH), and a Sounding Reference Signal (SRS). In addition, as a configuration for each reference signal, an IE such as a CSI-RS resource or an SRS-resource or the like may be used, and this configuration may include information associated with the beam. The information associated with the beam may mean whether a corresponding configuration (e.g., CSI-RS resource) uses the same spatial domain filter of another configuration (e.g., another CSI-RS resource in the same CSI-RS resource set) or uses another spatial domain filter, or to which reference signal it is subjected to Quasi-Co-Located (QCL), and if it is subjected to the QCL, which type (e.g., QCL type A, B, C, D) it is.

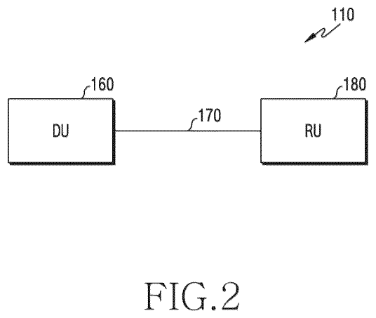

Conventionally, in a communication system having a relatively large cell radius of a base station, each base station is installed to include functions of a digital processing unit (or a Digital Unit (DU)) and a Radio Frequency (RF) processing unit (or a Radio Unit (RU)). However, since a higher frequency band is used and a cell radius of a base station is decreased in a 4^{th} Generation (4G) and/or next-generation communication system, the number of base stations for covering a specific region is increased, and an installation cost burden of an operator is increased to install the increased number of base stations. In order to minimize the installation cost of the base station, a structure is proposed in which the DU and the RU of the base station are separated such that one or more RUs are coupled to one DU through a wired network, and one or more RUs geographically distributed to cover the specific region are disposed. Hereinafter, a structure of disposing the base station and extended examples thereof will be described according to one or more embodiments of the disclosure with reference to FIG. 2.

FIG. 2 illustrates an example of a fronthaul structure based on a functional split of a base station according to one or more embodiments of the disclosure. A fronthaul refers to a connection from one entity to another, between a WLAN and the base station, unlike a backhaul between the base station and a core network. Although an example of a fronthaul structure between a DU 160 and one RU 180 is illustrated in FIG. 2, this is only for convenience of explanations, and the disclosure is not limited thereto. In other words, an embodiment of the disclosure may also apply to a fronthaul structure between one DU and a plurality of RUs. For example, an embodiment of the disclosure may apply to a fronthaul structure between one DU and two RUs. In addition, an embodiment of the disclosure may also apply to a fronthaul structure between one DU and three RUs.

Referring to FIG. 2, the base station 110 may include the DU 160 and the RU 180. A fronthaul 170 between the DU 160 and the RU 180 may be operated through an Fₓ interface. For the operation of the fronthaul 170 between the DU 160 and the RU 180, for example, an interface such as enhanced Common Public Radio Interface (eCPRI) or Radio Over Ethernet (ROE) may be used.

With the development of communication technology, mobile data traffic increases, which results in a significant increase in a bandwidth required in a fronthaul between a DU and an RU. In a deployment such as a Centralized/Cloud Radio Access Network (C-RAN), the DU may be realized to perform functions for Packet Data Convergence Protocol (PDCP), Radio Link Control (RLC), Media Access Control (MAC), and Physical (PHY), and the RU may be realized to further perform functions for the PHY layer in addition to a Radio Frequency (RF) function.

The DU 160 may be in charge of an upper layer function of a wireless network. For example, the DU 160 may perform a function of the MAC layer and some functions of the PHY layer. Herein, some functions of the PHY layer are performed at a higher level among functions of the PHY layer, and may include, for example, channel encoding (or channel decoding), scrambling (or descrambling), modulation (or demodulation), layer mapping (or layer demapping). According to an embodiment, when the DU 160 conforms to the O-RAN standard, it may be referred to as an O-RAN DU (O-DU). Optionally, the DU 160 may be represented by being replaced with a first network entity for a base station (e.g., gNB) in embodiments of the disclosure.

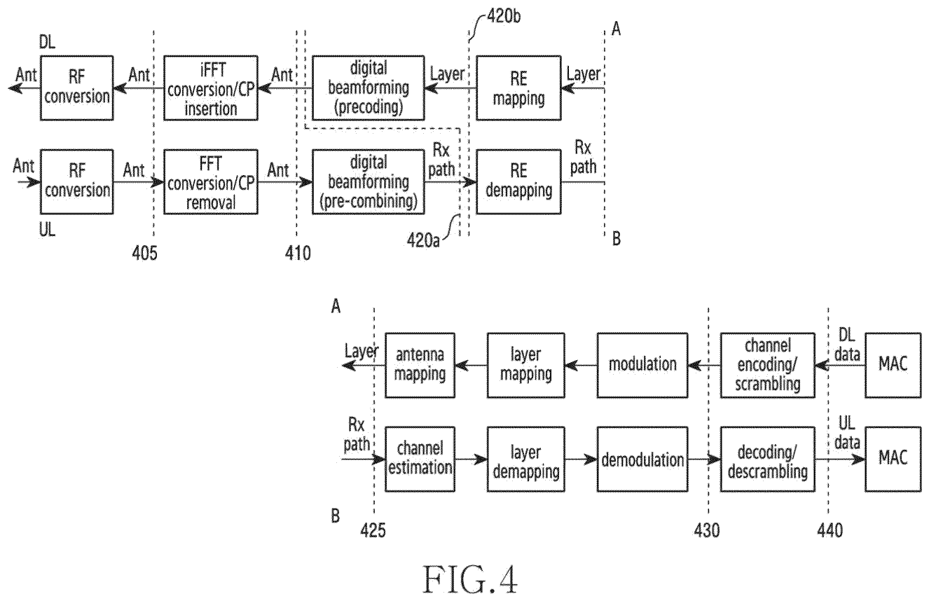

The RU 180 may be in charge of a lower layer function of the wireless network. For example, the RU 180 may perform some functions of the PHY layer and an RF function. Herein, some functions of the PHY layer are performed at a relatively lower level than the DU 160 among the functions of the PHY layer, and may include, for example, IFFT conversion (or FFT conversion), CP insertion (CP removal), and digital beamforming. An example of such a function split is described in detail with reference to FIG. 4. The RU 180 may be referred to as an ‘Access Unit (AU)’, an ‘Access Point (AP)’, a ‘Transmission/Reception Point (TRP)’, a Remote Radio Head (RRH), a ‘Radio Unit (RU)’, or other terms having equivalent technical meanings. According to an embodiment, when the RU 180 conforms to the O-RAN standard, it may be referred to as an O-RAN RU (O-RU). Optionally, the RU 180 may be represented by being replaced with a second network entity for a base station (e.g., gNB) in embodiments of the disclosure.

Although it is described in FIG. 2 that the base station includes the DU and the RU, one or more embodiments of the disclosure are not limited thereto. In some embodiments, the base station may be realized with a distributed deployment based on a Centralized Unit (CU) configured to perform a function of upper layers (e.g., Packet Data Convergence Protocol (PDCP), RRC) of an access network and a Distributed Unit (DU) configured to perform a function of a lower layer. In this case, the Distributed Unit (DU) may include the Digital Unit (DU) and Radio Unit (RU) of FIG. 2. Between a core (e.g., 5G Core (5GC) or Next Generation Core (NGC)) network and a wireless network (RAN), the base station may be realized in a structure in which the CU, the DU, and the RU are deployed in that order. An interface between the CU and the Distributed Unit (DU) may be referred to as an F1 interface.

The CU may be coupled to one or more DUs so as to be in charge of a function of an upper layer than the DU. For example, the CU may be in charge of a function of a Radio Resource Control (RRC) and Packet Data Convergence Protocol (PDCP) layer, and the DU and the RU may be in charge of a function of a lower layer. The DU may perform some functions (high PHY) of Radio Link Control (RLC), Media Access Control (MAC), Physical (PHY) layers, and the RU may be in charge of the remaining functions (low PHY) of the PHY layer. In addition, for example, a Digital Unit (DU) may be included in a Distributed Unit (DU) according to a distributed deployment realization of the base station. Hereinafter, although operations of the Digital Unit (DU) and RU are described unless otherwise defined, one or more embodiments of the disclosure may be applied to both a case where a base station including the CU is disposed and a case where the DU is coupled directly to a core network (i.e., the CU and the DU are realized by being integrated as one entity, i.e., a base station (e.g., NG-RAN node)).

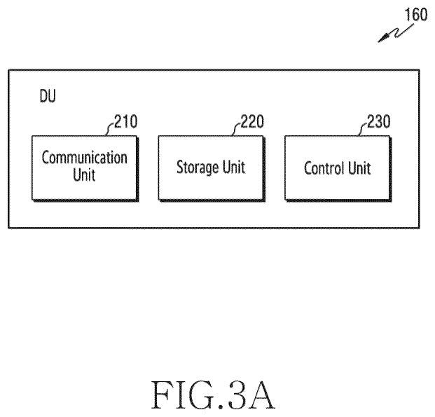

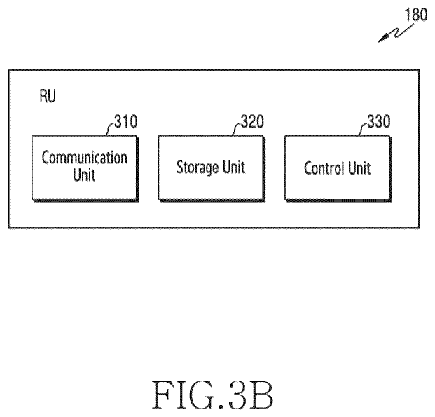

FIG. 3A illustrates a structure of a Digital Unit (DU) in a wireless communication system according to one or more embodiments of the disclosure. The exemplary structure of FIG. 3A may be understood as a structure of the DU 160 of FIG. 2. Hereinafter, the term ‘ . . . unit’, ‘ . . . device’, or the like implies a unit of processing at least one function or operation, and may be implemented in hardware or software or in combination of the hardware and the software.

Referring to FIG. 3A, the DU 160 includes a communication unit (or communication circuit) 210, a storage unit (or storage) 220, and a control unit (or controller) 230.

The communication circuit 210 may perform functions for transmitting/receiving a signal in a wired communication environment. The communication circuit 210 may include a wired interface for controlling a direct connection between one device and another device via a transmission medium (e.g., a copper wire, an optical fiber). For example, the communication circuit 210 may transfer an electrical signal to another device via the copper wire, or may perform a conversion between the electrical signal and an optical signal. The communication circuit 210 may be coupled to a Radio Unit (RU). The communication circuit 210 may be coupled to a core network or may be coupled to a Central Unit (CU) deployed in a distributed manner.

The communication circuit 210 may perform functions for transmitting/receiving a signal in a wireless communication environment. For example, the communication circuit 210 may perform a function of conversion between a baseband signal and a bit-stream according to a physical layer standard of a system. For example, in data transmission, the communication circuit 210 generates complex symbols by coding and modulating a transmitted bit-stream. In addition, in data reception, the communication circuit 210 restores a received bit-stream through demodulation and decoding of a baseband signal. In addition, the communication circuit 210 may include a plurality of transmission/reception paths. In addition, according to an embodiment, the communication circuit 210 may be coupled to a core network or may be coupled to other nodes, for example, Integrated Access Backhaul (IAB).

The communication circuit 210 may transmit and receive a signal. For this, the communication circuit 210 may include at least one transceiver. For example, the communication circuit 210 may transmit a synchronization signal, a reference signal, system information, a message, a control message, a stream, control information, data, or the like. In addition, the communication circuit 210 may perform beamforming.

The communication circuit 210 transmits and receives a signal as described above. Accordingly, all or part of the communication circuit 210 may be referred to as a ‘transmitter’, a ‘receiver’, or a ‘transceiver’. In addition, in the following description, transmission and reception performed through a radio channel mean to include the aforementioned process performed by the communication circuit 210.

In an embodiment, the communication circuit 210 may further include a backhaul communication circuit to be coupled to the core network or a different base station. The backhaul communication circuit provides an interface for performing communication with different nodes in a network. That is, the backhaul communication circuit converts a bit-stream transmitted from the base station to a different node, for example, a different access node, a different base station, a higher node, a core network, or the like, into a physical signal, and converts the physical signal received from the different node into a bit-stream.

The storage 220 stores data such as a basic program, application program, configuration information, or the like for an operation of the DU 160. The storage 220 may include a memory. The storage 220 may be constructed of a volatile memory, a non-volatile memory, or a combination of the volatile memory and the non-volatile memory. In addition, the storage 220 provides stored data according to a request of the controller 230.

The controller 230 controls overall operations of the DU 160. For example, the controller 230 transmits and receives a signal via the communication circuit 210 (or via the backhaul communication circuit). Further, the controller 230 writes data to the storage 220 and reads the data. In addition, the communication circuit 230 may perform functions of a protocol stack required in a communication standard. For this, the controller 230 may include at least one processor.

The structure of the DU 160 of FIG. 3A is only an example, and the example of the DU performing one or more embodiments of the disclosure is not limited to the structure illustrated in FIG. 3A. The structure may be added, deleted, or changed in part according to one or more embodiments.

FIG. 3B illustrates a structure of a Radio Unit (RU) in a wireless communication system according to one or more embodiments of the disclosure. The exemplary structure of FIG. 3B may be understood as a structure of the RU 180 of FIG. 2. Hereinafter, the term ‘ . . . unit’, ‘ . . . device’, or the like implies a unit of processing at least one function or operation, and may be implemented in hardware or software or in combination of the hardware and the software.

Referring to FIG. 3B, the RU 180 includes a communication unit (or communication circuit) 310, a storage unit (or storage) 320, and a control unit (or controller) 330.

The communication circuit 310 may perform functions for transmitting and receiving a signal through a radio channel. For example, the communication circuit 310 may up-convert a baseband signal into an RF-band signal and thereafter transmit it through an antenna, and may down-convert an RF-band signal received through the antenna into a baseband signal. For example, the communication circuit 310 may include a transmission filter, a reception filter, an amplifier, a mixer, an oscillator, a Digital-to-Analog Converter (DAC), an Analog-to-Digital Converter (ADC), or the like.

In addition, the communication circuit 310 may include a plurality of transmission/reception paths. Further, the communication circuit 310 may include an antenna unit. The communication circuit 310 may include at least one antenna array constructed of a plurality of antenna elements. From a hardware aspect, the communication circuit 310 may be constructed of a digital circuit and an analog circuit (e.g., a Radio Frequency Integrated Circuit (RFIC)). Herein, the digital circuit and the analog circuit may be realized as one package. In addition, the communication circuit 310 may include a plurality of RF chains. The communication circuit 310 may perform beamforming. In order to assign a directivity depending on a configuration of the controller 330 to a signal to be transmitted/received, the communication circuit 310 may apply a beamforming weight to the signal. According to an embodiment, the communication circuit 310 may include a Radio Frequency (RF) block (or an RF unit).

In addition, the communication circuit 310 may transmit and receive a signal. For this, the communication circuit 310 may include at least one transceiver. The communication circuit 310 may transmit a downlink signal. The downlink signal may include a Synchronization Signal (SS), a Reference Signal (RS) (e.g., Cell-specific Reference Signal (CRS), Demodulation (DM)-RS), system information (e.g., MIB, SIB, Remaining System Information (RMSI), Other System Information (OSI)), a configuration message, control information, downlink data, or the like. In addition, the communication circuit 310 may receive an uplink signal. The uplink signal may include a random access-related signal (e.g., Random Access Preamble (RAP) (or Message 1 (Msag1), Message 3 (Msg3)), a reference signal (e.g., Sounding Reference Signal (SRS), DM-RS), a Power Headroom Report (PHR), or the like.

The communication circuit 310 transmits and receives a signal as described above. Accordingly, all or part of the communication circuit 310 may be referred to as a ‘transmitter’, a ‘receiver’, or a ‘transceiver’. In addition, in the following description, transmission and reception performed through a radio channel mean to include the aforementioned process performed by the communication circuit 310.

The storage 320 stores data such as a basic program, application program, configuration information, or the like for an operation of the RU 180. The storage 320 may be constructed of a volatile memory, a non-volatile memory, or a combination of the volatile memory and the non-volatile memory. In addition, the storage 320 provides stored data according to a request of the controller 330. According to an embodiment, the storage 320 may include a memory for a condition, command, or setting value related to an SRS transmission method.

The controller 330 controls overall operations of the RU 180. For example, the controller 330 transmits and receives a signal via the communication circuit 310. Further, the controller 330 writes data to the storage 320, and reads the data. In addition, the communication circuit 330 may perform functions of a protocol stack required in a communication standard. For this, the controller 330 may include at least one processor. In some embodiments, the controller 330 may be configured to transmit an SRS to the DU 160, based on an antenna number. In addition, in some embodiments, the controller 330 may be configured to transmit the SRS to the DU 160, after uplink transmission. As an instruction set or code stored in the storage 320, a setting value or a conditional command based on an SRS transmission scheme may be an instruction/code resided in the controller 330 at least temporarily or a storage space storing the instruction/code, or may be part of a circuitry constituting the controller 330. In addition, the controller 330 may include various modules for performing communication. According to one or more embodiments, the controller 330 may control the RU 180 to perform operations based on one or more embodiments described below.

FIG. 4 illustrates an example of a function split. With the development of wireless communication technology (e.g., with the instruction of a 5^{th} Generation (5G) communication system (or New Radio (NR) communication system)), a frequency band to be used further increases, and a cell radius of a base station becomes very small, which results in a further increase in the number of RUs required to be installed. In addition, in the 5G communication system, an amount of data to be transmitted increases up to more than 10 times, which results in a significant increase in transmission capacity of a wired network in which fronthaul transmission is achieved. Due to these factors, installation cost of the wired network may significantly increase in the 5G communication system. Therefore, in order to decrease the transmission capacity of the wired network and to reduce the installation cost of the wired network, technologies for reducing the transmission capacity of the fronthaul by allowing the RU to be in charge of some functions of the modem of the DU have been proposed, and these technologies may be referred to a ‘function split’. Although the 5G communication system is described in the disclosure, without being limited thereto, the disclosure may also apply to a 6^{th} Generation (6G) communication system in the same or similar manner.

In order to reduce the burden of the DU, a method in which the role of the RU responsible for only the RF function is extended to some functions of the physical layer is considered. In this case, the higher the layer of which functions are performed by the RU, the greater the throughput of the RU, which results in an increase in a transmission bandwidth in the fronthaul. At the same time, a requirement constraint for a delay time caused by response processing may be reduced. Meanwhile, the higher the layer of which functions are performed by the RU, the lower the virtualization gain and the higher the size/weight/cost of the RU. It is required to realize an optimal function split by considering a trade-off of the aforementioned advantages and disadvantages.

Referring to FIG. 4, function splits in a Physical (PHY) layer below an MAC layer is illustrated. In a Downlink (DL) case in which a signal is transmitted to a terminal through a wireless network, a base station may sequentially perform channel encoding/scrambling, modulation, layer mapping, antenna mapping, RE mapping, digital beamforming (e.g., precoding), IFFT conversion/CP insertion, and RF conversion. In case of an Uplink (UL) in which a signal is received from the terminal through the wireless network, the base station may sequentially perform RF conversion, FFT conversion/CP removal, digital beamforming (pre-combining), RE demapping, channel estimation, layer demapping, demodulation, and decoding/descrambling. The split for UL functions and DL functions may be defined in various types depending on necessity between vendors, discussion on standards, or the like according to the aforementioned trade-off.

A first function split 405 may be a split of the RF function and the PHY function. The first function split is when the PHY function in the RU is not realized in practice, and for example, may be referred to as Option 8. A second function split 410 allows the RU to perform IFFT conversion/CP insertion in DL of the PHY function and FFT conversion/CP removal in UL, and allows the DU to perform the remaining PHY functions. For example, the second function split 410 may be referred to as Option 7-1. A third function split 420a allows the RU to perform IFFT conversion/CP insertion in DL and FFT conversion/CP removal in UL and beamforming, and allows the DU to perform the remaining PHY functions. For example, the third function split 420a may be referred to as Option 7-2x Category A. A fourth function split 420b allows the RU to perform up to digital beamforming in both DL and UL, and allows the DU to perform higher PHY functions after digital beamforming. For example, the fourth function split 420b may be referred to as Option 7-2x Category B. A fifth function split 425 allows the RU to perform up to RE mapping (or RE demapping) in both DL and UL, and allows the DU to perform higher PHY functions after RE mapping (or RE demapping). For example, the fifth function split 425 may be referred to as Option 7-2. A sixth function split 430 allows the RU to perform up to modulation (or demodulation) in both DL and UL, and allows the DU to perform higher PHY functions after modulation (or demodulation). For example, the sixth function split 430 may be referred to as Option 7-3. A seventh function split 440 allows the RU to perform up to encoding/scrambling (or decoding/descrambling) in both DL and UL, and allows the DU to perform higher PHY functions after modulation (or demodulation). For example, the seventh function split 440 may be referred to as Option 6.

According to an embodiment, when large-capacity signal processing is expected as in FR1 MMU, a function split at a relatively upper layer (e.g., the fourth function split 420b) may be required to reduce fronthaul capacity. In addition, a function split at an extremely high layer (e.g., the sixth function split 430) may have a complicated control interface and may cause a burden on the realization of the RU because a plurality of PHY processing blocks are included in the RU. Therefore, an appropriate function split may be required according to a method of deploying and realizing the DU and the RU.

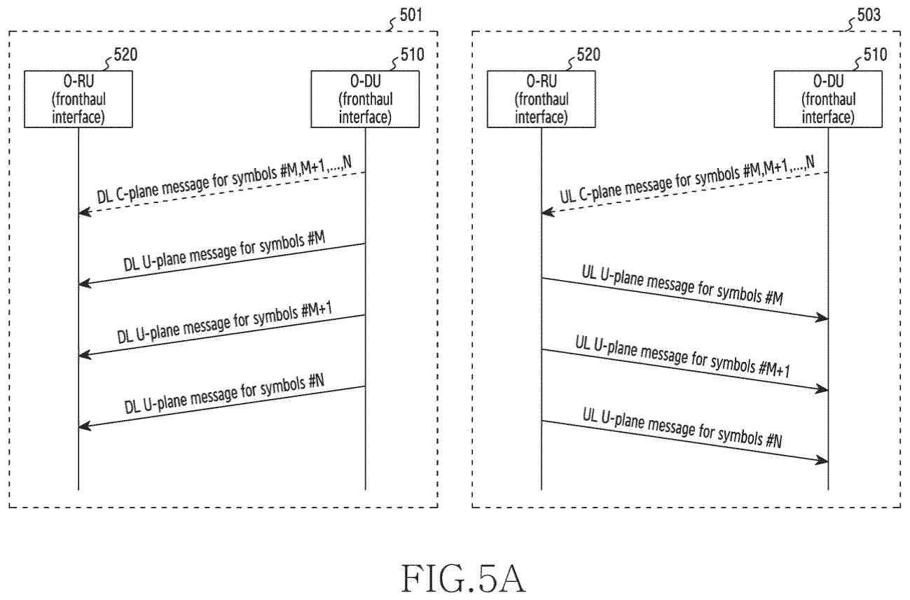

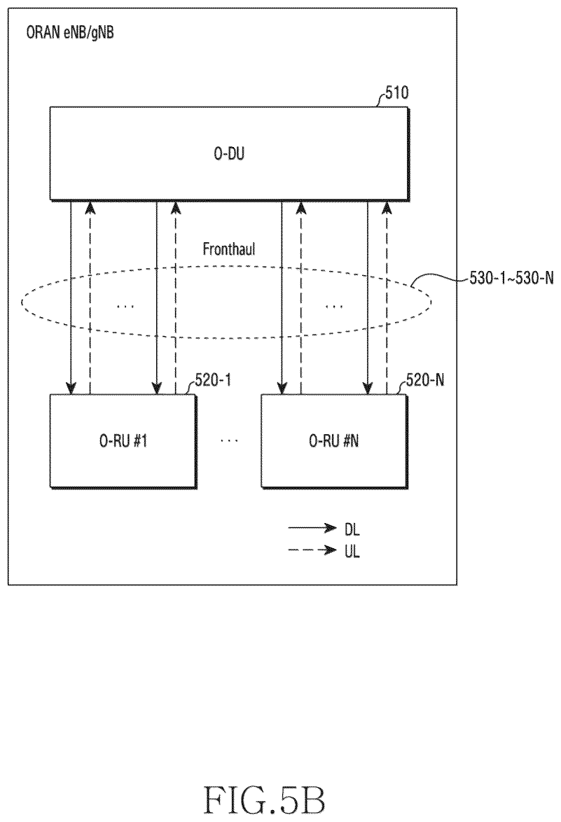

According to an embodiment, when it is not possible to process precoding of data received from the DU (that is, when there is a limitation in precoding capability of the RU), the third function split 420a or a function split lower than that (e.g., the second function split 410) may be applied. On the contrary, when it is possible to process the precoding of the data received from the DU, the fourth function split 420b or a function split higher than that (e.g., the sixth function split 430) may be applied. Hereinafter, one or more embodiments of the disclosure are described based on the third function split 420a (category A) or fourth function split 420b (category B) for performing a beamforming process in the RU unless otherwise limited, but it does not mean to exclude a configuration of an embodiment through other function split. A functional configuration, signaling, or operation of FIG. 5A to FIG. 13 described below may be applied not only to the third function split 420a or the fourth function split 420b but also other function splits.

According to one or more embodiments of the disclosure, standards of eCPRI and O-RAN are described for example as a fronthaul interface, when a message is transmitted between a DU (e.g., the DU 160 of FIG. 2) and an RU (e.g., the RU 180 of FIG. 2). An eCPRI header and an O-RAN header, and an additional field may be included in an Ethernet payload of a message. Although one or more embodiments of the disclosure are described hereinafter by using terms of the standard of eCPRI or O-RAN, other expressions having the same meaning as the respective terms may be used instead in one or more embodiments of the disclosure.

A transport protocol of the fronthaul may use Ethernet and eCPRI which are easily shared with a network. An eCPRI header and an O-RAN header may be included in an Ethernet payload. The eCPRI header may be located in front of the Ethernet payload. The content of the eCPRI header is as follows.
ecpriVersion (4 bits): 0001b (fixed value)
ecpriReserved (3 bits): 0000b (fixed value)
ecpriConcatenation (1 bit): 0b (fixed value)
ecpriMessage (1 byte): Message type
ecpriPayload (2 bytes): Payload size in bytes
ecpriRtcid/ecpriPcid (2 bytes): x, y, and z may be configured through a Management plane (M-plane). This field may indicate a transmission path (an extended Antenna-carrier (eAxC) in eCPRI) of a control message according to one or more embodiments in multi-layer transmission.
CU_Port_ID (x bits): Identify a channel card. Identification is possible by including even a modem (2 bits for channel card, 2 bits for Modem)
BandSector_ID (y bits): Identification based on cell/sector
CC_ID (z bits): Identification based on component carrier
RU_Port_ID (w bits): Identification based on layer, T, antenna, etc.
ecpriSeqid (2 bytes): Sequence ID is managed for each ecpriRtcid/ecpriPcid, and Sequence ID and subsequence ID are managed separately. Radio-transport-level fragmentation is possible when using Subsequence ID (different from Application-level fragmentation).

An application protocol of the fronthaul may include a Control plane (C-plane), a User plane (U-plane), a Synchronization plane (S-plane), and a Management plane (M-plane).

The C-plane may be configured to provide scheduling information and beamforming information through the control message. The U-plane may include user's DL data (IQ data or SSB/RS), UL data (IQ data or SRS/RS), or PRACH data. A weight vector of the aforementioned beamforming information may be multiplied by the user's data. The S-plane may be related to timing and synchronization. The M-plane may be related to initial setup, non-realtime reset or reset, and non-realtime report.

To define a type of a message transmitted in the C-plane, a section type is defined. The section type may indicate a usage of the control message transmitted in the C-plane. For example, a usage for each section type is as follows.
sectionType=0: DL idle/guard periods—Tx blanking usage for power saving
sectionType=1: Mapping of BF index or weight to RE of DL/UL channel (in O-RAN mandatory BF manner)
sectionType=2: Reserved
sectionType=3: Mapping of beamforming index or weight to RE of PRACH and mixed-numerology channel
sectionType=4: reserved
sectionType=5: Transfer of UE scheduling information (in O-RAN optional BF manner) so that RU is capable of calculating BF weight on real-time basis
sectionType=6: Transfer of UE channel information (in O-RAN optional BF manner) periodically so that RU is capable of calculating BF weight on real-time basis
sectionType=7: Used to support LAA

An eCPRI-based fronthaul interface used in O-RAN at present supports an LTE communication system and an NR communication system. Since it is possible to support a multi-cell with a small number of DUs by virtualizing the DUs, a method in which another communication system is also supported in the DU may be required. According to embodiments of the disclosure, the eCPRI-based fronthaul interface may support a Global System for Mobile communications (GSM). Hereinafter, the disclosure exemplifies the GSM as another communication system. However, it does not mean to exclude applying of other communication schemes (e.g., Wideband Code Division Multiple Access (WCDMA), Code Division Multiple Access (CDMA), etc.).

The GSM is a Timed Division Multiplexing Access (TDMA)-based communication scheme, as a 2^{nd} generation communication standard. CPRI supports the GSM. A method for applying the GSM to the eCPRI of the O-RAN is described, based on a fronthaul interface of the CPRI.

FIG. 5A illustrates a scheduling scenario in an O-RAN-based fronthaul interface according to embodiments of the disclosure.

Referring to FIG. 5A, in an embodiment, a DL Control plane (C-plane) message is transmitted (see 501). The DL C-plane message may be transmitted by an O-DU 510 to an O-RU 520. For example, the DL C-plane message may be a DL C-plane message for a slot #M to a slot #N. After the DL C-plane message is transmitted, the O-DU 510 may transmit a DL User plane (U-plane) message to the O-RU 520. For example, the DL U-plane message may be a DL U-plane message for the slot #M to the slot #N.

In an embodiment, a UL C-plane message is transmitted (see 503). The UL C-plane message may be transmitted by the O-DU 510 to the O-RU 520. For example, the UL C-plane message may be a UL C-plane message for the slot #M to the slot #N. After the UL C-plane message is transmitted, the O-RU 520 may transmit a UL U-plane message to the O-DU 5107. For example, the UL U-plane message may be a UL U-plane message for the slot #M to the slot #N.

FIG. 5B illustrates an example of a structure of a base station in an O-RAN-based fronthaul interface according to embodiments of the disclosure.

Referring to FIG. 5B, in the O-RAN-based fronthaul interface, the structure of the base station may include the O-DU 510 and one or more O-RUs 520-1 to 520-N (e.g., O-RU #1, O-RU #2, . . . , O-RU #N). The O-DU 510 and the one or more O-RUs 520-1 to 520-N may be coupled through one or more fronthauls 530-1 to 530-N. That is, the O-DU 510 may be coupled to each O-RU through a corresponding fronthaul.

Hereinafter, descriptions on each of the one or more O-RUs 520-1 to 520-N may be applied as descriptions on the O-RU 520. In addition, descriptions on each of the one or more fronthauls 530-1 to 530-N may be applied as descriptions on the fronthaul 530.

According to an embodiment, the O-RAN-based interface may correspond to Option 7-2x in the function split of FIG. 4. Specifically, the O-DU 510 may perform a high-PHY function for at least one of NR and LTE, and the O-RU 520 may perform a low-PHY function for at least one of NR and LTE. The high-PHY function may include scrambling (or descrambling), modulation (or demodulation), layer mapping (or channel estimation), and RE mapping (or RE demapping). The low-PHY function may include iFFT and CP insertion (or FFT and CP removal), and DAC (or ADC).

The fronthaul 530 may be a path through which data corresponding to an O-RAN packet is transferred between the O-DU 510 and the O-RU 520.

The O-DU 510 may transmit a DL message. Specifically, the O-DU 510 may transmit the DL message to the O-RU 520. The DL message may be a message including a packet corresponding to a DL C-plane. The DL message may be a message including a packet corresponding to a UL C-plane. The DL message may be a message including a packet corresponding to a DL U-plane. The DL message may be a message including a packet corresponding to a synchronization plane. The DL message may be a message including a packet corresponding to a management plane.

The O-RU 520 may transmit a UL message. Specifically, the O-RU 520 may transmit the UL message to the O-DU 510. The UL message may include a packet corresponding to a UL U-plane. The UL message may include a packet corresponding to a synchronization plane. The UL message may be a message including a packet corresponding to a management plane.

A radio wave arrival band is short in a 5G or 6G band according to a high-frequency characteristic. Therefore, more base stations are required to overcome straightness of radio waves and a shorter coverage characteristic compared to 4G communication. High density of the base stations causes an increase in power consumed in a cellular network. Therefore, a method for power saving is required when operating the base station. For the power saving, embodiments of the disclosure propose an apparatus and method for power saving in a fronthaul between an O-DU and O-RU of an O-RAN-based base station.

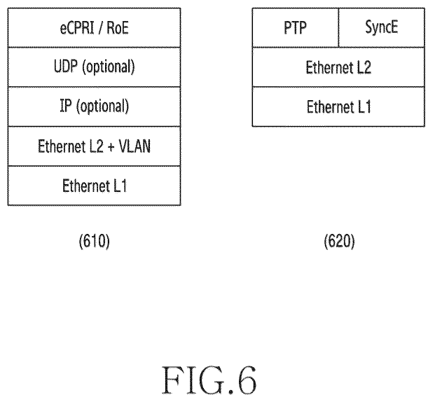

Embodiments of the disclosure propose a power saving apparatus and method for saving power by generating a control signal for powering off a transmitter, when a radio resource is not allocated. For example, embodiments of the disclosure propose a power saving apparatus and method for powering off, by identifying a case where a radio resource is not allocated, based on obtained scheduling information. Specifically, embodiments of the disclosure propose a power saving apparatus and method for powering off a transmitter, when data corresponding to a DL C-plane packet, data corresponding to a UL C-plane packet, and a DL U-plane packet are all absent. Hereinafter, a power saving method is described with reference to FIG. 6 to FIG. 13.

FIG. 6 illustrates examples of a protocol structure of messages in an O-RAN-based fronthaul interface according to embodiments of the disclosure. Specifically, FIG. 6 illustrates a message protocol structure 610 of each of a Control plane (C-plane) and a User plane (U-plane) and a protocol structure 620 of a Synchronization plane (S-plane).

Referring to FIG. 6, the message protocol structure 610 of each of the C-plane and the U-plane may include an Ethernet L1 layer, an Ethernet L2 layer+Virtual Local Area Network (VLAN), an Internet Protocol (IP) layer (optional), a User Datagram Protocol (UDP) layer (optional), and an enhanced Common Public Radio Interface (eCPRI)/Radio Over Ethernet (ROE) layer.

The protocol structure 620 of the S-plane may include an Ethernet L1 layer, an Ethernet L2 layer, a Precision Time Protocol (PTP) layer, and a Synchronous Ethernet (SyncE) layer.

In the O-RAN-based fronthaul interface, an application protocol may include a Control plane (C-plane), a User plane (U-plane), a Synchronization plane (S-plane), and a Management plane (M-plane).

A message related to the C-plane may be a message which provides scheduling information and beamforming information. For example, a message related to the scheduling information may be a message including section ID information, beam ID information, or UE ID information. The message related to the C-plane may be transmitted through the message protocol structure 610 of each of the C-plane and the U-plane.

A message related to the U-plane may be a message including user's DL data (IQ data or SSB/RS), UL data (IQ data or SRS/RS), or PRACH data. The message related to the U-plane may be transmitted through the message protocol structure 610 of each of the C-plane and the U-plane.

A message related to the S-plane may be related to timing and synchronization. For example, the message related to the S-plane may be a message including data transmitted for synchronization between the O-DU and the O-RU. The message related to the S-plane may be transmitted through the protocol structure 620 of the S-plane.

A message related to the M-plane may be a message related to initial setup, non-realtime reset or reset, and non-realtime report.

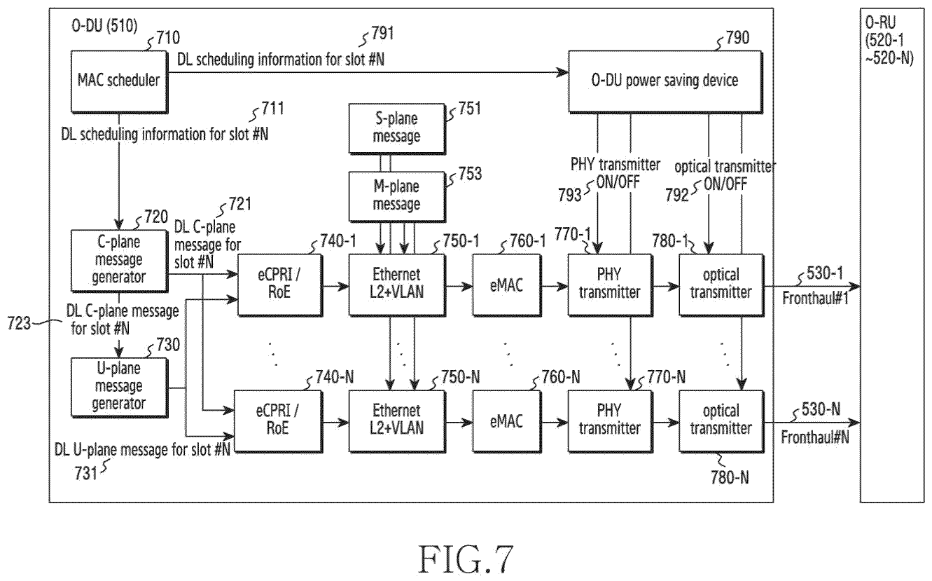

FIG. 7 illustrates an example of an O-DU (O-RAN DU) in an O-RAN-based fronthaul interface according to an embodiment of the disclosure.

Referring to FIG. 7, in the O-RAN-based fronthaul interface, the base station may include the O-DU 510 and one or more O-RUs 520-1 to 520-N. The O-DU 510 and the one or more O-RUs 520-1 to 520-N may be coupled through one or more fronthauls 530-1 to 530-N. In addition, the O-DU 510 may include a Media Access Control (MAC) scheduler 710, a C-plane message generator 720, a U-plane message generator 730, one or more eCPRI/ROEs 740-1 to 740-N, one or more Ethernet L2+VLANs 750-1 to 750-N, an S-plane message 751, an M-plane message 753, one or more Ethernet Media Access Controllers (eMACs) 760-1 to 760-N, one or more Physical (PHY) transmitters 770-1 to 770-N, and one or more optical transmitters 780-1 to 780-N. In addition, the O-DU 510 may include an O-DU power saving engine 790.

Hereinafter, descriptions on each of the one or more O-RUs 520-1 to 520-N may be applied as descriptions on the O-RU 520. In addition, descriptions on each of the one or more fronthauls 530-1 to 530-N may be applied as descriptions on the fronthaul 530. In addition, descriptions on each of the one or more eCPRI/ROEs 740-1 to 740-N may be applied as descriptions on the eCPRI/ROE 740. In addition, descriptions on each of the one or more Ethernet L2+VLANs 750-1 to 750-N may be applied as descriptions on the Ethernet L2+VLAN 750. In addition, descriptions on each of the one or more eMACs 760-1 to 760-N may be applied as descriptions on the eMAC 760. In addition, descriptions on each of the one or more PHY transmitters 770-1 to 770-N may be applied as descriptions on the PHY transmitter 770. In addition, descriptions on each of the one or more optical transmitters 780-1 to 780-N may be applied as descriptions on the optical transmitter 780.

The C-plane message may be generated based on scheduling information obtained from the MAC scheduler 710. In addition, the U-plane message may be generated based on the scheduling information obtained from the MAC scheduler 710. For example, the DL C-plane message may be generated based on DL scheduling information 711 for a slot #N, obtained from the MAC scheduler 710. In addition, the UL C-plane message may be generated based on the UL scheduling information 711 for the slot #N, obtained from the MAC scheduler 710. As another example, the DL U-plane message may be generated based on a DL C-plane message 723 received from the C-plane message generator 720. Hereinafter, C-plane message transmission 1), U-plane message transmission 2), and S-plane message and M-plane message transmission 3) will be described.

### 1. C-Plane Message Transmission

A C-plane message for a slot #N may be generated based on the DL or UL scheduling information 711 for the slot #N, obtained from the MAC scheduler 710.

For example, the C-plane message generator 720 may generate a DL C-plane message for the slot #N, based on the DL scheduling information 711 for the slot #N, obtained from the MAC scheduler 710. Specifically, the C-plane message generator 720 may identify whether there is DL scheduling information, based on the DL scheduling information 711 for the slot #N, obtained from the MAC scheduler 710. Since the C-plane message generator 720 identifies whether there is DL scheduling information, based on the DL scheduling information 711 for the slot #N, the DL C-plane message for the slot #N may be generated based on whether the identified DL scheduling information is present.

As another example, the C-plane message generator 720 may generate a UL C-plane message for the slot #N, based on the UL scheduling information 711 for the slot #N, obtained from the MAC scheduler 710. Specifically, the C-plane message generator 720 may identify whether there is UL scheduling information, based on the UL scheduling information 711 for the slot #N, obtained from the MAC scheduler 710. Since the C-plane message generator 720 identifies whether there is UL scheduling information, the UL C-plane message for the slot #N may be generated based on whether the identified UL scheduling information is present.

The C-plane message generator 720 may transmit the generated DL C-plane message for the slot #N to the eCPRI/ROE 740 (see 721). In addition, the C-plane message generator 720 may transmit the generated DL C-plane message for the slot #N to the U-plane message generator 730 (see 723). The DL U-plane message may be generated as a DL U-plane message for the slot #N, based on the DL C-plane message for the slot #N, transmitted to the U-plane message generator 730. In addition, the C-plane message generator 720 may transmit the generated UL C-plane message for the slot #N to the eCPRI/ROE 740 (see 721).

1) When there is DL Scheduling Information

In an embodiment, the C-plane message generator 720 identifies that there is DL scheduling information (a case where it is identified that there is DL scheduling information, based on the DL scheduling information for the slot #N, obtained from the MAC scheduler 710). Since the C-plane message generator 720 identifies that there is DL scheduling information, the C-plane message generator 720 may generate the DL C-plane message for the slot #N.

The generated DL C-plane message for the slot #N may be transmitted to the O-RU 520, in order to allocate a DL resource for the slot #N. For example, the generated DL C-plane message for the slot #N may be transmitted to the O-RU 520 through the fronthaul 530. Specifically, the generated DL C-plane message for the slot #N may be transmitted to the O-RU 520 through the eCPRI/ROE 740, the Ethernet L2+VLAN 750, the eMAC 760, the PHY transmitter 770, the optical transmitter 780, and the fronthaul 530.

In addition, the generated DL C-plane message for the slot #N may be transmitted to the U-plane message generator 730 in order to generate the DL U-plane message for the slot #N (see 723).

2) When there is UL Scheduling Information

In an embodiment, the C-plane message generator 720 identifies that there is UL scheduling information for the slot #N (a case where it is identified that there is UL scheduling information, based on the UL scheduling information for the slot #N, obtained from the MAC scheduler 710). If the C-plane message generator 720 identifies that there is UL scheduling information for the slot #N, the C-plane message generator 720 may generate the UL C-plane message for the slot #N.

The generated UL C-plane message for the slot #N may be transmitted to the O-RU 520, in order to allocate a UL resource for the slot #N. For example, the generated UL C-plane message for the slot #N may be transmitted to the O-RU 520 through the fronthaul 530. Specifically, the generated UL C-plane message for the slot #N may be transmitted to the O-RU 520 through the eCPRI/ROE 740, the Ethernet L2+VLAN 750, the eMAC 760, the PHY transmitter 770, the optical transmitter 780, and the fronthaul 530.

3) When there is No DL Scheduling Information

In an embodiment, the C-plane message generator 720 identifies that there is no DL scheduling information for the slot #N (a case where it is identified that there is no DL scheduling information, based on the DL scheduling information for the slot #N, obtained from the MAC scheduler 710). Since the C-plane message generator 720 identifies that there is no DL scheduling information for the slot #N, the C-plane message generator 720 does not generate the DL C-plane message for the slot #N.

Since the DL C-plane message for the slot #N is not generated, the DL C-plane message for the slot #N is not transmitted to the O-RU 520. The DL C-plane message for the slot #N is not transmitted to the O-RU 520 through the eCPRI/ROE 740, the Ethernet L2+VLAN 750, the eMAC 760, the PHY transmitter 770, the optical transmitter 780, and the fronthaul 530.

4) When there is No UL Scheduling Information

In an embodiment, the C-plane message generator 720 identifies that there is no UL scheduling information for the slot #N (a case where it is identified that there is no UL scheduling information, based on the UL scheduling information for the slot #N, obtained from the MAC scheduler 710). Since the C-plane message generator 720 identifies that there is no UL scheduling information for the slot #N, the C-plane message generator 720 does not generate the UL C-plane message for the slot #N.

Since the UL C-plane message for the slot #N is not generated, the UL C-plane message for the slot #N is not transmitted to the O-RU 520. The UL C-plane message for the slot #N is not transmitted to the O-RU 520 through the eCPRI/ROE 740, the Ethernet L2+VLAN 750, the eMAC 760, the PHY transmitter 770, the optical transmitter 780, and the fronthaul 530.

### 2. U-Plane Message Transmission

1) When there is DL Scheduling Information

In an embodiment, the C-plane message generator 720 identifies that there is DL scheduling information (a case where it is identified that there is DL scheduling information, based on the DL scheduling information for the slot #N, obtained from the MAC scheduler 710). Since the C-plane message generator 720 identifies that there is DL scheduling information, the U-plane message generator 730 may generate the DL U-plane message for the slot #N. Specifically, the U-plane message generator 730 may generate the DL U-plane message for the slot #N, based on the received DL C-plane message 723 for the slot #N.

The generated DL U-plane message for the slot #N may be transmitted to the O-RU 520. For example, the generated DL U-plane message for the slot #N may be transmitted to the O-RU 520 through the fronthaul 530. Specifically, the generated DL U-plane message for the slot #N may be transmitted to the O-RU 520 through the eCPRI/ROE 740, the Ethernet L2+VLAN 750, the eMAC 760, the PHY transmitter 770, the optical transmitter 780, and the fronthaul 530.

2) When there is UL Scheduling Information

In an embodiment, the C-plane message generator 720 identifies that there is UL scheduling information for the slot #N (a case where it is identified that there is UL scheduling information, based on the UL scheduling information for the slot #N, obtained from the MAC scheduler 710). Since the C-plane message generator 720 identifies that there is UL scheduling information for the slot #N, the C-plane message generator 720 may generate the UL C-plane message for the slot #N.

The O-RU 520 may generate the UL U-plane message for the slot #N, based on the received UL C-plane message for the slot #N. As such, when there is UL scheduling information, since the UL U-plane message for the slot #N is generated and transmitted by not the O-DU 510 but the O-RU 520, the O-DU 510 is not a subject for generating and transmitting the U-plane message.

3) When there is No DL Scheduling Information

In an embodiment, the C-plane message generator 720 identifies that there is no DL scheduling information for the slot #N (a case where it is identified that there is no DL scheduling information, based on the DL scheduling information for the slot #N, obtained from the MAC scheduler 710). Since the C-plane message generator 720 identifies that there is no DL scheduling information for the slot #N, the C-plane message generator 720 does not generate the DL C-plane message for the slot #N. In addition, the U-plane message generator 730 does not generate the DL U-plane message for the slot #N. Specifically, since the DL C-plane message for the slot #N is not generated by the C-plane message generator 720, the generated DL C-plane message for the slot #N is not transmitted to the U-plane message generator 730. Therefore, since there is no transmitted DL C-plane message for the slot #N, the U-plane message generator 730 is not able to generate the DL U-plane message for the slot #N.

Since the DL C-plane message and DL U-plane message for the slot #N are not generated, the DL C-plane message and DL U-plane message for the slot #N are not transmitted to the O-RU 520. Specifically, the DL C-plane message for the slot #N is not transmitted to the O-RU 520 through the eCPRI/ROE 740, the Ethernet L2+VLAN 750, the eMAC 760, the PHY transmitter 770, the optical transmitter 780, and the fronthaul 530.

In addition, since the DL U-plane message for the slot #N is not generated, DL U-plane message for the slot #N is not transmitted to the O-RU 520. Specifically, the DL U-plane message for the slot #N is not transmitted to the O-RU 520 through the eCPRI/ROE 740, the Ethernet L2+VLAN 750, the eMAC 760, the PHY transmitter 770, the optical transmitter 780, and the fronthaul 530.

4) When there is No UL Scheduling Information

In an embodiment, the C-plane message generator 720 identifies that there is no UL scheduling information for the slot #N (a case where it is identified that there is no UL scheduling information, based on the UL scheduling information for the slot #N, obtained from the MAC scheduler 710). When there is no UL scheduling information for the slot #N, the C-plane message generator 720 does not generate the UL C-plane message for the slot #N.

Since the UL C-plane message for the slot #N is not generated, the UL C-plane message for the slot #N is not transmitted to the O-RU 520. Specifically, the UL C-plane message for the slot #N is not transmitted to the O-RU 520 through the eCPRI/ROE 740, the Ethernet L2+VLAN 750, the eMAC 760, the PHY transmitter 770, the optical transmitter 780, and the fronthaul 530.

### 3. Transmission of S-Plane Message and M-Plane Message

An S-plane message is generated by the S-plane message generator 751, and an M-plane message is generated by the M-plane message generator 753. The S-plane message is transmitted to the O-RU 520 through the Ethernet L2+VLAN 750, the eMAC 760, the PHY transmitter 770, the optical transmitter 780, and the fronthaul 530. In addition, the M-plane message is transmitted to the O-RU 520 through the Ethernet L2+VLAN 750, the eMAC 760, the PHY transmitter 770, the optical transmitter 780, and the fronthaul 530.

When there are no DL scheduling information and UL scheduling information for the slot #N, the DL C-plane message, UL C-plane message, and DL U-plane message for the slot #N are not transmitted to the O-RU 520. In addition, if the fronthaul 530 is not used in transmission of the S-plane message and the M-plane message, the S-plane message and the M-plane message are not transmitted to the O-RU 520. Even though no message is transmitted, a state in which the PHY transmitter 770 and the optical transmitter 780 are powered on may cause waste of power. Therefore, it is proposed a method of saving power by generating a control signal for powering off a transmitter, when there are no DL scheduling information and UL scheduling information. Specifically, it is proposed a method of saving power in which the power saving device 790 identifies that there are no DL scheduling information and UL scheduling information, and upon identifying that a fronthaul is not used in transmission of an S-plane message and an M-plane message, generates a control signal for powering off a transmitter.

Although the disclosure describes a method of saving power by generating a control signal for powering off a transmitter, another method of saving power is also possible. For example, power of the transmitter may be blocked. As another example, current transferred to the transmitter may be blocked. As another example, power supplied to the transmitter may be reduced. As another example, the transmitter may be powered off only in part. As another example, it is also possible to change a path.

Hereinafter, a type of information input to the power saving device 790 for saving power is described.

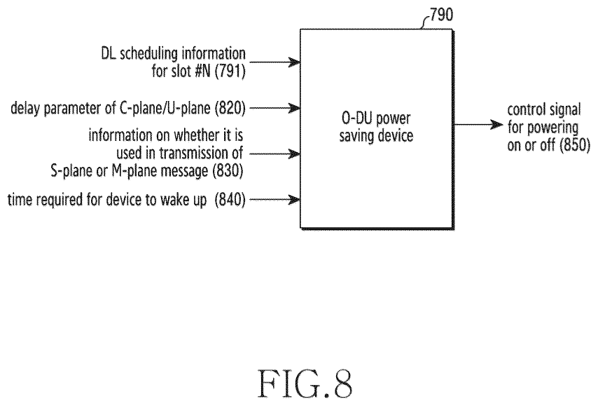

FIG. 8 illustrates an example of information input to a power saving device and a signal output thereto in an O-RAN-based fronthaul interface according to embodiments of the disclosure.

Referring to FIG. 8, the power saving device 790 may obtain scheduling information 791 for a slot #N. For example, the power saving device 790 may obtain DL scheduling information for the slot #N from the MAC scheduler 710. The power saving device 790 may identify whether there is DL scheduling information, based on the obtained DL scheduling information for the slot #N. As another example, the power saving device 790 may obtain the UL scheduling information for the slot #N from the MAC scheduler 710. The power saving device 790 may identify whether there is UL scheduling information, based on the obtained UL scheduling information for the slot #N.

When there are no DL scheduling information and UL scheduling information, the power saving device 790 performs a power saving operation. The power saving operation means that the power saving device 790 generates a control signal for powering off the PHY transmitter 770 and the optical transmitter 780 in order to save power for an interval without the DL scheduling information and the UL scheduling information. Although a method of saving power by generating a control signal for powering off a transmitter is described, another method of saving power is also possible. For example, power of the transmitter may be blocked. As another example, current transferred to the transmitter may be blocked. As another example, power supplied to the transmitter may be reduced. As another example, the transmitter may be powered off only in part. As another example, it is also possible to change a path.

The power saving device 790 may obtain a delay parameter 820. The delay parameter 820 may include a delay parameter of a C-plane and a delay parameter of a U-plane. In addition, the parameter of the C-plane may include a delay parameter of a C-plane for DL. In addition, the delay parameter of the C-plane may include a delay parameter of a C-plane for UL. In addition, a delay parameter of a U-plane may include a delay parameter of a U-plane for DL.

A DL C-plane message for the slot #N has a start timing. In addition, the DL C-plane message for the slot #N has an end timing. A transmission window of the DL C-plane message for the slot #N may be defined as being between the starting timing of the DL C-plane message for the slot #N and the end timing of the DL C-plane message for the slot #N.

In addition, the UL C-plane message for the slot #N has a start timing. In addition, the UL C-plane message for the slot #N has an end timing. A transmission window of the UL C-plane message for the slot #N may be defined as being between the starting timing of the UL C-plane message for the slot #N and the end timing of the UL C-plane message for the slot #N.

In addition, the DL U-plane message for the slot #N has a start timing. In addition, the DL U-plane message for the slot #N has an end timing. A transmission window of the DL U-plane message for the slot #N may be defined as being between the starting timing of the DL U-plane message for the slot #N and the end timing of the DL U-plane message for the slot #N.

The delay parameter 820 may include a delay parameter corresponding to the start timing of the DL C-plane message for the slot #N. In addition, the delay parameter 820 may include a delay parameter corresponding to the end timing of the DL C-plane message for the slot #N. The transmission window of the DL C-plane message for the slot #N may be obtained based on the delay parameter corresponding to the start timing of the DL C-plane message for the slot #N and the delay parameter corresponding to the end timing.

In addition, the delay parameter 820 may include a delay parameter corresponding to the start timing of the UL C-plane message for the slot #N. In addition, the delay parameter 820 may include a delay parameter corresponding to the end timing of the UL C-plane message for the slot #N. The transmission window of the UL C-plane message for the slot #N may be obtained based on the delay parameter corresponding to the start timing of the UL C-plane message for the slot #N and the delay parameter corresponding to the end timing.

In addition, the delay parameter 820 may include a delay parameter corresponding to the start timing of the DL U-plane message for the slot #N. In addition, the delay parameter 820 may include a delay parameter corresponding to the end timing of the DL U-plane message for the slot #N. The transmission window of the DL U-plane message for the slot #N may be obtained based on the delay parameter corresponding to the start timing of the DL U-plane message for the slot #N and the delay parameter corresponding to the end timing.

The power saving device 790 may obtain indication information 830 on whether the fronthaul 530 is used in transmission of an S-plane or M-plane message. Specifically, the power saving device 790 may identify whether the fronthaul 530 is used in transmission of the S-plane message, based on the indication information 830. In addition, the power saving device 790 may identify whether the fronthaul 530 is used in transmission of the M-plane message, based on the indication information 830. For example, in an embodiment, the power saving device 790 identifies that the fronthaul 530 is used in transmission of the S-plane message, based on the indication information 830. When the power saving device 790 identifies that the fronthaul 530 is used in transmission of the S-plane message, based on the indication information 830, the power saving device 790 does not generate a control signal for powering off the PHY transmitter 770 and the optical transmitter 780. This is because power saving for the C-plane and U-plane messages is unnecessary when the fronthaul 530 is used in transmission of the S-plane message. When the fronthaul 530 is not used in transmission of the S-plane message, the power saving device 790 may perform the power saving operation according to embodiments of the disclosure.

In addition, in an embodiment, the power saving device 790 identifies that the fronthaul 530 is used in transmission of the M-plane message, based on the indication information 830. When the power saving device 790 identifies that the fronthaul 530 is used in transmission of the M-plane message, based on the indication information 830, the power saving device 790 does not generate a control signal for powering off the PHY transmitter 770 and the optical transmitter 780. This is because power saving for the C-plane and U-plane messages is unnecessary when the fronthaul 530 is used in transmission of the M-plane message. When it is not used in transmission of the M-plane message, the power saving device 790 may perform the power saving operation according to embodiments of the disclosure. That is, when the fronthaul 530 is not used in transmission of the S-plane message, the power saving device 790 may generate a control signal for reducing power in an interval without the DL C-plane message, the UL C-plane message, and the DL U-plane message.

That is, when the fronthaul 530 is not used in transmission of any one of the S-plane message and the M-plane message, the power saving device 790 may generate a control signal for reducing power in the interval without the DL C-plane message, the UL C-plane message, and the DL U-plane message.

As another example, in an embodiment, the power saving device 790 identifies that the fronthaul 530 is not used in transmission of the S-plane or M-plane message, based on information 830 on whether the fronthaul 530 is used in transmission of the S-plane or M-plane message. Upon identifying that the fronthaul 530 is not used in transmission of the S-plane or M-plane message, the power saving device 790 may perform a power saving operation. The power saving device 790 may perform the power saving operation, based on the obtained DL/UL scheduling information 791 for the slot #N. When there are no DL scheduling information and the UL scheduling information, the power saving device 790 may perform the power saving operation. The power saving operation means that the power saving device 790 generates a control signal for powering off the PHY transmitter 770 and the optical transmitter 780 in order to save power for an interval without the DL scheduling information and the UL scheduling information.

The power saving device 790 may obtain a normalization time 840. The normalization time 840 means a time required, when power is on, until it is normalized after power is on. The normalization time 840 may be used to determine a timing at which the PHY transmitter 770 and the optical transmitter 780 are powered on. For example, in an embodiment, the PHY transmitter 770 and the optical transmitter 708 are powered on based on the DL/UL scheduling information 791 for the slot #N (a case where it is identified that there is no DL/UL scheduling information for the slot #N). When it is identified that there is DL scheduling information for a slot #N+1 upon being powered off, the PHY transmitter 770 and the optical transmitter 780 shall be powered on, for transmission of a DL C-plane message for the slot #N+1. When it is identified that there is DL scheduling information for the slot #N+1 upon being powered off, the PHY transmitter 770 and the optical transmitter 780 shall be powered on, for transmission of a DL U-plane message for the slot #N+1. When it is identified that there is UL scheduling information for the slot #N+1 upon being powered off, the PHY transmitter 770 and the optical transmitter 780 shall be powered on, for transmission of a UL C-plane message for the slot #N+1.

Even after being powered on, it takes time until the PHY transmitter 770 and the optical transmitter 780 are normalized to transmit a message. Specifically, even after being powered on, the PHY transmitter 770 and the optical transmitter 780 shall be powered on earlier by the time 840 required for a device to wake up in advance than an earliest time among messages for the slot #N+1.

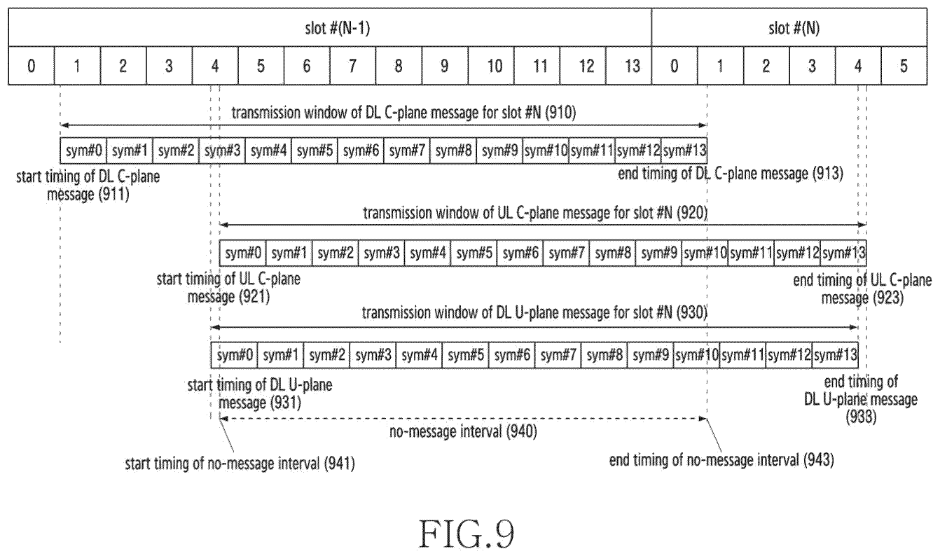

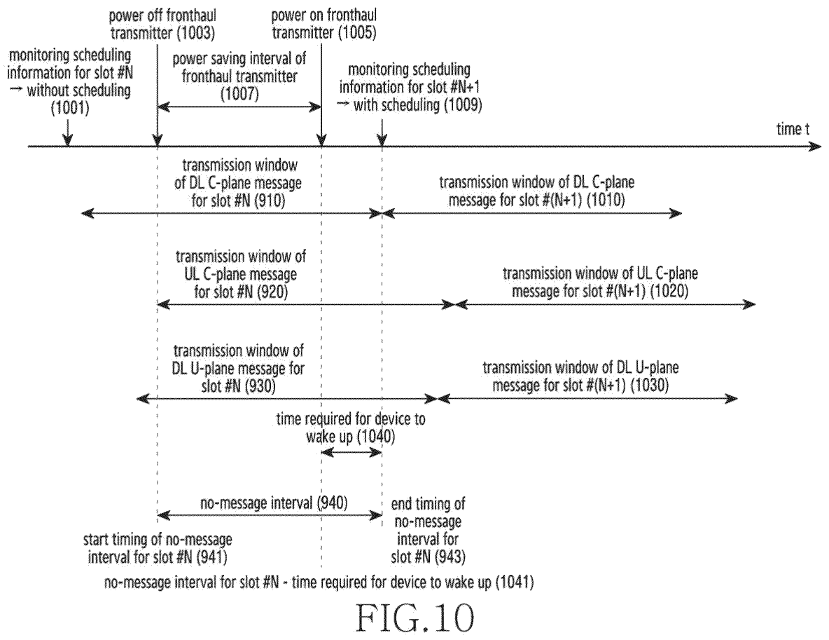

The power saving device 790 may transmit a control signal 850 for powering on or off. The power saving device 790 is used to save power. For example, when the PHY transmitter 770 and the optical transmitter 780 are not used, the power saving device 790 is used to save power by generating a control signal for powering off the PHY transmitter 770 and the optical transmitter 780. Specifically, a case where the PHY transmitter 770 and the optical transmitter 780 are not used may mean a case where the DL C-plane message, UL C-plane message, and DL U-plane message for the slot #N are not transmitted to the O-RU 520 since there are no DL scheduling information and UL scheduling information for the slot #N. In addition, the power saving device 790 may need to power on the PHY transmitter 770 and the optical transmitter 780 when the PHY transmitter 770 and the optical transmitter 780 are used. Specifically, a case where the PHY transmitter 770 and the optical transmitter 780 are used may mean a case where the DL C-plane message is transmitted to the O-RU 520 since there is DL scheduling information. In addition, a case where the PHY transmitter 770 and the optical transmitter 780 are used may mean a case where the DL U-plane message is transmitted to the O-RU 520 since there is DL scheduling information. In addition, a case where the PHY transmitter 770 and the optical transmitter 780 are used may mean a case where the UL C-plane message is transmitted to the O-RU 520 since there is UL scheduling information. Hereinafter, examples of a scenario for power saving will be described with reference to FIG. 9 and FIG. 10.

FIG. 9 illustrates an example of an interval in which a C-plane message and a U-plane message are transmitted in an O-RAN-based fronthaul interface according to embodiments of the disclosure. Referring to FIG. 9, a transmission window 910 of a DL C-plane message for a slot #N, a transmission window 920 of a UL C-plane message for the slot #N, and a transmission window 930 of a DL U-plane message for the slot #N are illustrated.

The transmission window of the messages for the slot #N may be determined based on the obtained delay parameter 820 of the C-plane/U-plane. For example, the transmission window 910 of the DL C-plane message for the slot #N is constructed of a start timing 911 of the DL C-plane message for the slot #N and an end timing 913 of the DL C-plane message for the slot #N, based on the obtained delay parameter of the DL C-plane. As another example, the transmission window 920 of the UL C-plane message for the slot #N is constructed of a start timing 921 of the UL C-plane message for the slot #N and an end timing 923 of the UL C-plane message for the slot #N, based on the obtained delay parameter of the UL C-plane. As another example, the transmission window 930 of the DL U-plane message for the slot #N is constructed of a start timing 931 of the DL U-plane message for the slot #N and an end timing 933 of the DL U-plane message for the slot #N, based on the obtained delay parameter of the DL U-plane.

For example, in an embodiment, the power saving device 790 identifies that there are no DL scheduling information and UL scheduling information for the slot #N, based on the DL/UL scheduling information 791 for the slot #N. Upon identifying that there are no DL scheduling information and UL scheduling information for the slot #N, since there are no DL scheduling information and UL scheduling information for the slot #N, the DL C-plane message and UL C-plane message for the slot #N are not generated. Since the DL C-plane message is not generated, the DL U-plane message is not generated. When the DL C-plane message, the UL C-plane message, and the DL U-plane message are not generated, since the DL C-plane message, the UL C-plane message, and the DL U-plane message are not transmitted to the O-RU 520, the PHY transmitter 770 and the optical transmitter 780 are not used. When the PHY transmitter 770 and the optical transmitter 780 are not used, the power saving device 790 may save power by generating a control signal for powering off the PHY transmitter 770 and the optical transmitter 780.

When all of the DL C-plane message, the UL C-plane message, and the DL U-plane message are not generated, all of the DL C-plane message, the UL C-plane message, and the DL U-plane message are not transmitted via the PHY transmitter 770 and the optical transmitter 780. Such an interval may be defined as a no-message interval 940. For this interval, the power saving device 790 may save power by generating a control signal for powering off the PHY transmitter 770 and the optical transmitter 780. Hereinafter, a start timing 941 and end timing 943 of the no-message interval 940 will be described.

### 1. The Start Timing 941 of the No-Message Interval 940

In an embodiment, the power saving device 790 may save power by generating a control signal for powering off the PHY transmitter 770 and the optical transmitter 780 since there are no DL scheduling information and UL scheduling information for the slot #N (a case where a DL C-plane message, UL C-plane message, and DL U-plane message for the slot #N are not generated). In order to save power, the power saving device 790 is required to identify the start timing 941 of the no-message interval 940 for the slot #N. This is because it is related to a timing for powering off the PHY transmitter 770 and the optical transmitter 780 for the slot #N. Considering that there is scheduling information for a slot #N−1, the start timing 941 of the no-message interval 940 for the slot #N shall be the latest timing 921 among the start timing 911 of the DL C-plane message for the slot #N, the start timing 921 of the UL C-plane message for the slot #N, and the start timing 931 of the DL U-plane message for the slot #N. To consider that there is scheduling information for a slot #N−1 means to consider a case where any one of the DL C-plane message, UL C-plane message and DL U-plane message for the slot #N is generated since there are DL scheduling information and UL scheduling information for the slot #N−1.

### 2. The End Timing 943 of the No-Message Interval 940

In an embodiment, the power saving device 790 needs to generate a control signal for powering on the PHY transmitter 770 and the optical transmitter 780 since there are DL scheduling information and UL scheduling information for the slot #N+1 (a case where at least one of the DL C-plane message, UL C-plane message, and DL U-plane message for the slot #N+1 is generated). In order to identify a timing for powering on, the power saving device 790 is required to identify the end timing 943 of the no-message interval 940 for the slot #N. This is because it is related to a timing for powering on the PHY transmitter 770 and the optical transmitter 780 for the slot #N+1. Considering that there is scheduling information for a slot #N+1, the end timing 943 of the no-message interval 940 shall be the earliest timing 913 among the end timing 913 of the DL C-plane message for the slot #N, the end timing 923 of the UL C-plane message for the slot #N, and the end timing 933 of the DL U-plane message for the slot #N. To consider that there is scheduling information for a slot #N+1 means to consider a case where any one of the DL C-plane message, UL C-plane message and DL U-plane message for the slot #N+1 is generated since there are DL scheduling information and UL scheduling information for the slot #N+1.

A timing at which the power saving device 790 powers off the PHY transmitter 770 and the optical transmitter 780 for the slot #N may correspond to the start timing 941 of the no-message interval 940. However, the timing at which the power saving device 790 powers on the PHY transmitter 770 and the optical transmitter 780 for the slot #N+1 is not determined only with the end timing 943 of the no-message interval 940. This is because the PHY transmitter 770 and the optical transmitter 780 may not operate properly during a time until the PHY transmitter 770 and the optical transmitter 780 are stabilized to transmit a message, after the PHY transmitter 770 and the optical transmitter 780 for the slot #N+1 are powered on.

Hereinafter, a timing at which the power saving device 790 powers on and off the PHY transmitter 770 and the optical transmitter 780 for the slot #N+1 is described, based on the no-message interval and the time until the PHY transmitter 770 and the optical transmitter 780 are stabilized to transmit a message.

FIG. 10 illustrates an example of an interval of saving power in an O-RAN-based fronthaul interface according to embodiments of the disclosure.

For example, in an embodiment, a case 1001 where there are no DL scheduling information and UL scheduling information for a slot #N and a case 1009 where there are DL scheduling information and UL scheduling information for a slot #N+1. In this case, a power saving interval 1007 of the PHY transmitter 770 and the optical transmitter 780 for the slot #N will be described. Specifically, a timing 1003 for powering off the PHY transmitter 770 and the optical transmitter 780 for the slot #N and a timing 1005 for powering on the PHY transmitter 770 and the optical transmitter 780 for the slot #N will be described.

### 1. Transmission Window of Messages for Slot #N

The transmission window of the messages for the slot #N may be determined based on the obtained delay parameter 820 of the C-plane/U-plane. The transmission window 910 of the DL C-plane message for the slot #N is constructed of the start timing 911 of the DL C-plane message for the slot #N and the end timing 913 of the DL C-plane message for the slot #N. The transmission window 920 of the UL C-plane message for the slot #N is constructed of the start timing 921 of the UL C-plane message for the slot #N and the end timing 923 of the UL C-plane message for the slot #N. The transmission window 930 of the DL U-plane message for the slot #N is constructed of the start timing 931 of the DL U-plane message for the slot #N and the end timing 933 of the DL U-plane message for the slot #N.

### 2. Transmission Window of Messages for Slot #N+1

The transmission window of the messages for the slot #N+1 may be determined based on the obtained delay parameter 820 of the C-plane/U-plane. A transmission window 1010 of the DL C-plane message for the slot #N+1 is constructed of the start timing of the DL C-plane message for the slot #N+1 and the end timing of the DL C-plane message for the slot #N+1. A transmission window 1020 of the UL C-plane message for the slot #N+1 is constructed of the start timing of the UL C-plane message for the slot #N+1 and the end timing of the UL C-plane message for the slot #N+1. A transmission window 1030 of the DL U-plane message for the slot #N+1 is constructed of the start timing of the DL U-plane message for the slot #N+1 and the end timing of the DL U-plane message for the slot #N+1.

### 3. The Timing 1003 for Powering Off the PHY Transmitter 770 and the Optical Transmitter 780

In an embodiment, the power saving device 790 may save power by generating a control signal for powering off the PHY transmitter 770 and the optical transmitter 780 since there are no DL scheduling information and UL scheduling information for the slot #N (a case where a DL C-plane message, UL C-plane message, and DL U-plane message for the slot #N are not generated). In order to save power, it is required to identify the timing 1003 for powering off the PHY transmitter 770 and the optical transmitter 780 for the slot #N. This is related to the start timing 941 of the no-message interval 940 for the slot #N. Specifically, the timing 1003 for powering off is the latest timing 921 among the start timing 911 of the DL C-plane message for the slot #N, the start timing 921 of the UL C-plane message for the slot #N, and the start timing 931 of the DL U-plane message for the slot #N, which correspond to the start timing 941 of the no-message interval 940 for the slot #N.

### 4. The Timing 1005 for Powering on the PHY Transmitter 770 and the Optical Transmitter 780

In an embodiment, the power saving device 790 needs to generate a control signal for powering on the PHY transmitter 770 and the optical transmitter 780 since there are DL scheduling information and UL scheduling information for the slot #N+1 (a case where at least one of the DL C-plane message, UL C-plane message, and DL U-plane message for the slot #N+1 is generated). In order to save power, it is required to identify the timing 1005 for powering on the PHY transmitter 770 and the optical transmitter 780 for the slot #N. This is related to the end timing 940 of the no-message interval 940 for the slot #N. In addition, it is related to a time 1040 until the PHY transmitter 770 and the optical transmitter 780 are stabilized to transmit a message, after the PHY transmitter 770 and the optical transmitter 780 for the slot #N+1 are powered on. The time 1040 until the PHY transmitter 770 and the optical transmitter 780 are stabilized to transmit the message, after the PHY transmitter 770 and the optical transmitter 780 for the slot #N+1 are powered on, may be based on the time 840 required for the device to wake up. The timing 1005 for powering on the optical transmitter 780 may be a value 1041 obtained by subtracting the time 1040 until the PHY transmitter 770 and the optical transmitter 780 are stabilized to transmit the message from the end timing 943 of the no-message interval 940 for the slot #N. This is because the PHY transmitter 770 and the optical transmitter 780 may not operate properly during the time 1040 until the PHY transmitter 770 and the optical transmitter 780 are stabilized to transmit a message, after the PHY transmitter 770 and the optical transmitter 780 for the slot #N+1 are powered on.

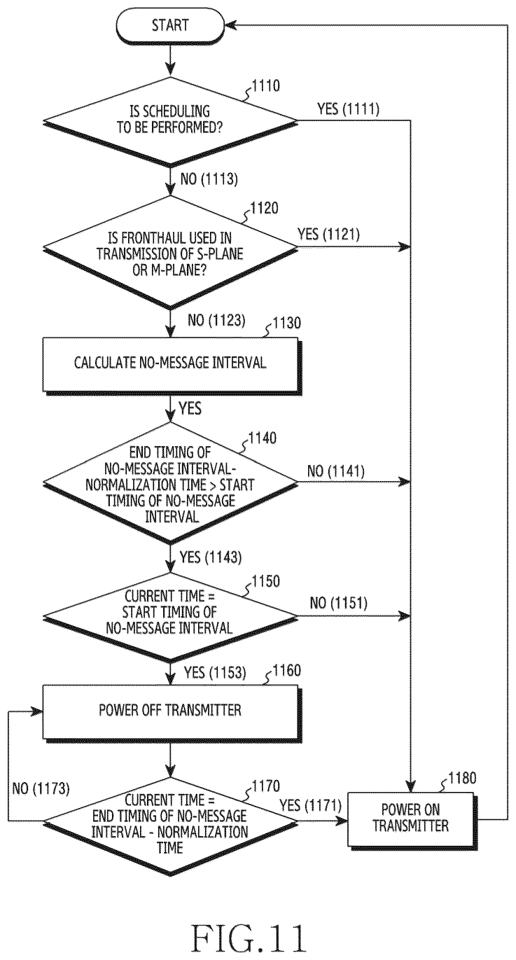

FIG. 11 illustrates a flowchart for saving power in a power saving device in an O-RAN-based fronthaul interface according to an embodiment of the disclosure.

In operation 1110, the power saving device 790 monitors scheduling information for a slot. For example, the power saving device 790 may obtain the DL/UL scheduling information 791 for the slot. If there is scheduling information (see 1111), the power saving device 790 maintains a state 1180 in which the PHY transmitter 770 and the optical transmitter 680 are powered on. If there is no scheduling information (see 1113), the power saving device 790 needs to identify whether the fronthaul 530 is used in transmission of an S-plane or an M-plane.

In operation 1120, the power saving device 790 identifies whether the fronthaul 530 is used in transmission of the S-plane or the M-plane. For example, based on the information 830 on whether the fronthaul 530 is used in transmission of the S-plane or the M-plane, the power saving device 790 may identify whether the fronthaul 530 is used in transmission of the S-plane or the M-plane. If the power saving device 790 identifies that the fronthaul 530 is used in transmission of the S-plane or the M-plane (see 1121), the power saving device 790 maintains the state 1180 in which the PHY transmitter 770 and the optimal transmitter 780 are powered on. If the power saving device 790 identifies that the fronthaul 530 is not used in transmission of the S-plane or the M-plane (see 1123), the power saving device 790 calculates a no-message interval.

In operation 1130, the power saving device 790 calculates the no-message interval. For example, the no-message interval is calculated based on a start timing of the no-message interval and an end timing of the no-message interval. The start timing of the no-message interval shall be a latest timing among a start timing of a DL C-plane message, a start timing of a UL C-plane message, and a start timing of a DL U-plane message. In addition, an end timing of the no-message interval shall be an earliest timing among an end timing of the DL C-plane message, an end timing of a UL C-plane message, and an end timing of a DL U-plane message.

In operation 1140, the power saving device 790 determines whether a timing obtained by subtracting the time 840 required for the device to wake up from the end timing of the no-message interval is later than the start timing of the no-message interval. This is because power saving is possible for an interval based on a timing obtained by subtracting the time 840 required for the device to wake up from the end timing of the no-message interval. If the timing obtained by subtracting the time 840 required for the device to wake up from the end timing of the no-message interval is earlier than the start timing of the no-message interval (see 1141), the power saving device 790 maintains the state 1180 in which the PHY transmitter 770 and the optical transmitter 780 are powered on. If the timing obtained by subtracting the time 840 required for the device to wake up from the end timing of the no-message interval is later than the start timing of the no-message interval (see 1143), the power saving device 790 identifies whether a current time is the start timing of the no-message interval.

In operation 1150, the power saving device 790 identifies whether the current time is the start timing of the no-message interval. If the current time is not the start timing of the no-message interval (see 1151), the power saving device 790 maintains the state 1180 in which the PHY transmitter 770 and the optimal transmitter 780 are powered on. If the current time is the start timing of the no-message interval (see 1153), the power saving device 790 generates a control signal for powering off, for a state 1160 in which the PHY transmitter 770 and the optimal transmitter 780 are powered off.

In operation 1170, the power saving device 790 identifies whether the current time is a timing obtaining by subtracting the time 840 required for the device to wake up from the end timing of the no-message interval. If the current time is the time 840 required for the device to wake up from the end timing of the no-message interval (see 1171), the power saving device 790 generates a control signal for powering on, for the state 1180 in which the PHY transmitter 770 and the optimal transmitter 780 are powered on. If the current time is not the time 840 required for the device to wake up from the end timing of the no-message interval (see 1173), the power-off state 1160 is maintained.

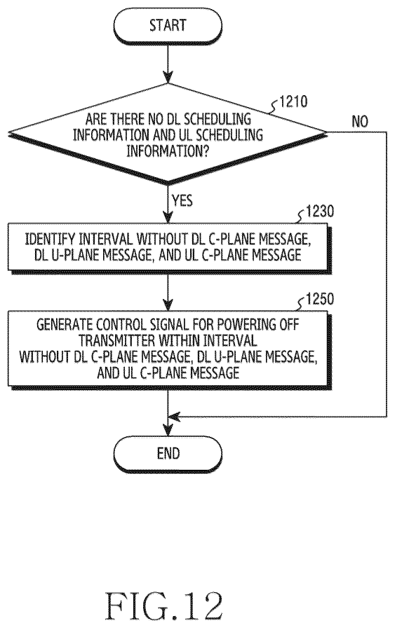

FIG. 12 illustrates a flowchart for saving power in a power saving device of a DU in an O-RAN-based fronthaul interface according to an embodiment of the disclosure.

In operation 1210, the power saving device 790 of the DU may identify whether there are no DL scheduling information and UL scheduling information. For example, in an embodiment, the power saving device 790 of the DU obtains the DL scheduling information and UL scheduling information 791 for the slot #N. The power saving device 790 of the DU may identify whether there are no DL scheduling information and UL scheduling information, based on the obtained DL scheduling information and UL scheduling information 791 for the slot #N.

In operation 1230, the power saving device 790 of the DU identifies an interval without the DL C-plane message, the UL C-plane message, and the DL U-plane message. For example, in an embodiment, the identified interval is the interval 940 without the DL C-plane message for the slot #N, the UL C-plane message for the slot #N, and the DL U-plane message for the slot #N. A start timing of the interval 940 without the C-plane message for the slot #N is the latest timing 921 among the start timing 911 of the DL C-plane message for the slot #N, the start timing 921 of the UL C-plane message for the slot #N, and the start timing 931 of the DL U-plane message for the slot #N. In addition, the end timing 943 of the no-message interval 940 for the slot #N is the earliest timing 913 among the end timing 913 of the DL C-plane message for the slot #N, the end timing 932 of the UL C-plane message for the slot #N, and the end timing 933 of the DL U-plane message for the slot #N.

In operation 1250, the power saving device 790 of the DU generates a control signal for powering off a transmitter of the DU within the interval without the DL C-plane message, the UL C-plane message, and the DL U-plane message. For example, in an embodiment, the control signal for powering off the PHY transmitter 770 and optical transmitter 780 of the DU is generated within the interval 940 without the DL C-plane message for the slot #N, the UL C-plane message for the slot #N, and the DL U-plane message for the slot #N.

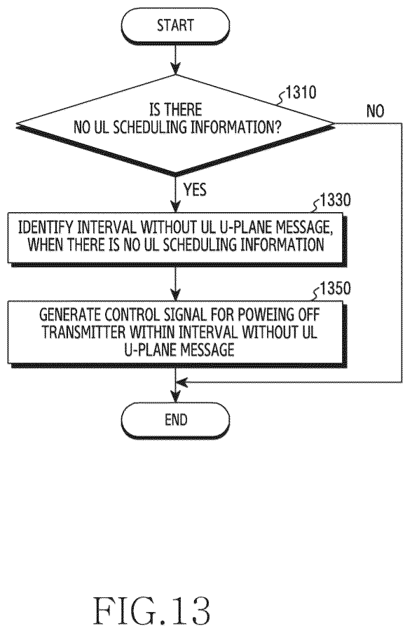

FIG. 13 illustrates a flowchart for saving power in a power saving device in an RU in an O-RAN-based fronthaul interface according to an embodiment of the disclosure.

In operation 1310, the power saving device of the RU may identify whether there is no UL scheduling information. For example, the power saving device of the RU may obtain UL scheduling information, based on a UL C-plane message received from a DU. For example, the power saving device of the RU may obtain the UL scheduling information for the slot #N, based on the UL C-plane message received from the DL for the slot #N. Based on the obtaining of the scheduling information, the power saving device of the RU may identify whether there is no UL scheduling information, based on the obtained UL scheduling information for the slot #N.

In operation 1330, the power saving device of the RU identifies an interval without the UL U-plane message. For example, in an embodiment, the interval without the UL U-plane message for the slot #N is identified. The interval without the UL U-plane message for the slot #N is the same as a transmission window of the UL U-plane message for the slot #N.

In operation 1350, the power saving device of the RU generates a control signal for powering off a transmitter within the interval without the UL U-plane message. For example, in an embodiment, the control signal for powering off the PHY transmitter and optical transmitter of the RU is generated within the interval without the UL U-plane message for the slot #N.

According to embodiments of the disclosure, a method performed by a Distributed Unit (DU) in a wireless communication system may include identifying whether there are no downlink scheduling information and uplink scheduling information for a specified slot, identifying an interval without a downlink Control plane (C-plane) message, an uplink C-plane message, and a downlink User plane (U-plane) message when there are no downlink scheduling information and uplink scheduling information for the specified slot, and generating a control signal for powering off a transmitter of the DU within the interval.

According to an embodiment, a start timing of the interval may correspond to a start timing of an interval without the downlink C-plane message, a start timing of an interval without the uplink C-plane message, and a start timing of an interval without the downlink U-plane message.

According to an embodiment, an end timing of the interval may be determined based on an earliest timing among an end timing of the interval without the downlink C-plane message, an end timing of the interval without the uplink C-plane message, and an end timing of the interval without the downlink U-plane message.

According to an embodiment, the end timing of the interval may be determined based on a time until the transmitter of the DU is stabilized to transmit a message after the transmitter of the DU is powered on.

According to an embodiment, the method may further include obtaining information on whether a fronthaul between the DU and a Radio Unit (RU) is used in transmission of a synchronization plane message and whether the fronthaul is used in transmission of a management plane message, and when the fronthaul is not used in transmission of the synchronization plane message and the fronthaul is not used in transmission of the management plane message, generating a control signal for powering off the transmitter of the DU within the interval.

According to an embodiment, the transmitter of the DU may include a Physical (PHY) transmitter and an optical transmitter.

According to embodiments of the disclosure, a method performed by an RU in a wireless communication system may include identifying whether there is no uplink scheduling information for a specified slot, when there is no uplink scheduling information for the specified slot, identifying an interval without an uplink U-plane message, and generating a control signal for powering off a transmitter of the RU within the interval.

According to an embodiment, a start timing of the interval may correspond to a start timing of an interval without the uplink U-plane message. An end timing of the interval may be determined based on an end timing of the interval without the uplink U-plane message.

According to an embodiment, the end timing of the interval may be determined based on a time until the transmitter of the RU is stabilized to transmit a message after the transmitter of the RU is powered on.

According to an embodiment, the method may further include obtaining information on whether a fronthaul between a DU and the RU is used in transmission of a synchronization plane message and whether the fronthaul is used in transmission of a management plane message, and when the fronthaul is not used in transmission of the synchronization plane message and the fronthaul is not used in transmission of the management plane message, generating a control signal for powering off the transmitter of the RU within the interval.

According to an embodiment, the transmitter of the RU may include a PHY transmitter and an optical transmitter.

According to embodiments of the disclosure, a DU in a wireless communication system may include a transmitter, and at least one processor coupled to the transmitter. The at least one processor may be configured to identify whether there are no downlink scheduling information and uplink scheduling information for a specified slot, identify an interval without a downlink C-plane message, an uplink C-plane message, and a downlink U-plane message when there are no downlink scheduling information and uplink scheduling information for the specified slot, and generate a control signal for powering off a transmitter of the DU within the interval.

According to an embodiment, a start timing of the interval may correspond to a start timing of an interval without the downlink C-plane message, a start timing of an interval without the uplink C-plane message, and a start timing of an interval without the downlink U-plane message.

According to an embodiment, an end timing of the interval may be determined based on an earliest timing among an end timing of the interval without the downlink C-plane message, an end timing of the interval without the uplink C-plane message, and an end timing of the interval without the downlink U-plane message.

According to an embodiment, the end timing of the interval may be determined based on a time until the transmitter of the DU is stabilized to transmit a message after the transmitter of the DU is powered on.

According to an embodiment, the at least one processor may be configured to obtain information on whether a fronthaul between the DU and an RU is used in transmission of a synchronization plane message and whether the fronthaul is used in transmission of a management plane message, and when the fronthaul is not used in transmission of the synchronization plane message and the fronthaul is not used in transmission of the management plane message, generate a control signal for powering off the transmitter of the DU within the interval.

According to an embodiment, the transmitter of the DU may include a PHY transmitter and an optical transmitter.

According to embodiments of the disclosure, an RU in a wireless communication system may include a transmitter, and at least one processor coupled to the transmitter. The at least one processor may be configured to identify whether there is no uplink scheduling information for a specified slot, when there is no uplink scheduling information for the specified slot, identify an interval without an uplink U-plane message, and generate a control signal for powering off a transmitter of the RU within the interval.

According to an embodiment, a start timing of the interval may correspond to a start timing of an interval without the uplink U-plane message. An end timing of the interval may be determined based on an end timing of the interval without the uplink U-plane message.

According to an embodiment, the end timing of the interval may be determined based on a time until the transmitter of the RU is stabilized to transmit a message after the transmitter of the RU is powered on.

According to an embodiment, the at least one processor may be configured to obtain information on whether a fronthaul between a DU and the RU is used in transmission of a synchronization plane message and whether the fronthaul is used in transmission of a management plane message, and when the fronthaul is not used in transmission of the synchronization plane message and the fronthaul is not used in transmission of the management plane message, generate a control signal for powering off the transmitter of the RU within the interval.

According to an embodiment, the transmitter of the RU may include a PHY transmitter and an optical transmitter.

Methods based on the embodiments disclosed in the claims and/or specification of the disclosure may be implemented in hardware, software, or a combination of both.

When implemented in software, computer readable recording medium for storing one or more programs (i.e., software modules) may be provided. The one or more programs stored in the computer readable recording medium are configured for execution performed by one or more processors in the electronic device. The one or more programs include instructions for allowing the electronic device to execute the methods based on the embodiments disclosed in the claims and/or specification of the disclosure.

The program (i.e., the software module or software) may be stored in a random access memory, a non-volatile memory including a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device may have access to a device for performing an embodiment of the disclosure via an external port. In addition, an additional storage device on a communication network may have access to the device for performing the embodiment of the disclosure.

In the aforementioned specific embodiments of the disclosure, a component included in the disclosure is expressed in a singular or plural form according to the specific embodiment proposed herein. However, the singular or plural expression is selected properly for a situation proposed for the convenience of explanation, and thus the one or more embodiments of the disclosure are not limited to a single or a plurality of components. Therefore, a component expressed in a plural form may also be expressed in a singular form, or vice versa.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description thereof but by the appended claims, and all differences within equivalents of the scope will be construed as being included in the disclosure.

What is claimed is:

1. A method performed by a Distributed Unit (DU) in a wireless communication system, the method comprising:
identifying whether there are no downlink scheduling information and uplink scheduling information for a slot;
when there are no downlink scheduling information and uplink scheduling information for the slot, identifying an interval without a downlink Control plane (C-plane) message, an uplink C-plane message, and a downlink User plane (U-plane) message; and
generating a control signal for powering off a transmitter of the DU within the identified interval.

2. The method of claim 1, wherein a start timing of the interval corresponds to a first start timing of a first interval without the downlink C-plane message, a second start timing of a second interval without the uplink C-plane message, and a third start timing of a third interval without the downlink U-plane message.

3. The method of claim 1, wherein an end timing of the interval is determined based on an earliest timing among a first end timing of a first interval without the downlink C-plane message, a second end timing of a second interval without the uplink C-plane message, and a third end timing of the a interval without the downlink U-plane message.

4. The method of claim 3, wherein the end timing of the interval is determined based on a time until the transmitter of the DU is stabilized to transmit a message after the transmitter of the DU is powered on.

5. The method of claim 1, further comprising:
obtaining information on whether a fronthaul between the DU and a Radio Unit (RU) is used in a transmission of a synchronization plane message and whether the fronthaul is used in a transmission of a management plane message; and
when the fronthaul is not used in the transmission of the synchronization plane message and the fronthaul is not used in the transmission of the management plane message, generating the control signal for powering off the transmitter of the DU within the interval.

6. The method of claim 1, wherein the transmitter of the DU comprises a Physical (PHY) transmitter and an optical transmitter.

7. A method performed by a Radio Unit (RU) in a wireless communication system, the method comprising:
identifying whether there is no uplink scheduling information for a slot;
when there is no uplink scheduling information for the slot, identifying an interval without an uplink User plane (U-plane) message; and
generating a control signal for powering off a transmitter of the RU within the interval.

8. The method of claim 7, wherein a start timing of the interval corresponds to a first start timing of a first interval without the uplink U-plane message, and
wherein an end timing of the interval is determined based on a first end timing of the first interval without the uplink U-plane message.

9. The method of claim 8, wherein the end timing of the interval is further determined based on a time until the transmitter of the RU is stabilized to transmit a message after the transmitter of the RU is powered on.

10. The method of claim 7, further comprising:
obtaining information on whether a fronthaul between a Distributed Unit (DU) and the RU is used in a transmission of a synchronization plane message and whether the fronthaul is used in a transmission of a management plane message; and
when the fronthaul is not used in the transmission of the synchronization plane message and the fronthaul is not used in the transmission of the management plane message, generating the control signal for powering off the transmitter of the RU within the interval.

11. A Distributed Unit (DU) in a wireless communication system, comprising:
a transmitter; and
at least one processor operatively coupled to the transmitter,
wherein the at least one processor is configured to:
identify whether there are no downlink scheduling information and uplink scheduling information for a slot;
when there are no downlink scheduling information and uplink scheduling information for the slot, identify an interval without a downlink Control plane (C-plane) message, an uplink C-plane message, and a downlink User plane (U-plane) message; and
generate a control signal for powering off the transmitter of the DU within the interval.

12. The DU of claim 11, wherein a start timing of the interval corresponds to a first start timing of a first interval without the downlink C-plane message, a second start timing of a second interval without the uplink C-plane message, and a third start timing of a third interval without the downlink U-plane message.

13. The DU of claim 11, wherein an end timing of the interval is determined based on an earliest timing among a first end timing of a first interval without the downlink C-plane message, a second end timing of a second interval without the uplink C-plane message, and a third end timing of a third interval without the downlink U-plane message.

14. The DU of claim 13, wherein the end timing of the interval is further determined based on a time until the transmitter of the DU is stabilized to transmit a message after the transmitter of the DU is powered on.

15. A Radio Unit (RU) in a wireless communication system, comprising:
a transmitter; and
at least one processor operatively coupled to the transmitter,
wherein the at least one processor is configured to:
identify whether there is no uplink scheduling information for a slot;
when there is no uplink scheduling information for the slot, identify an interval without an uplink User plane (U-plane) message; and
generate a control signal for powering off a transmitter of the RU within the interval.
